(19) United States
(12) Patent Application Publication
(10) Pub. No.: US 2025/0006912 A1
(43) Pub. Date: Jan. 2, 2025

(54) SOLID-STATE LITHIUM-ION BATTERIES WITH LONG CYCLE LIFE AND ULTRAFAST CHARGING

(71) Applicant: Tyfast, San Diego, CA (US)

(72) Inventors: Haodong LIU, San Diego, CA (US); Ping LIU, San Diego, CA (US); Gerardo Jose LA O', San Mateo, CA (US)

(21) Appl. No.: 18/756,013

(22) Filed: Jun. 27, 2024

Related U.S. Application Data
(60) Provisional application No. 63/524,256, filed on Jun. 30, 2023.

(51) Int. Cl. H01M 4/485; H01M 4/02; H01M 4/131; H01M 4/525; H01M 10/0525; H01M 10/0562

(52) U.S. Cl. CPC H01M 4/485; H01M 4/131; H01M 4/525; H01M 10/0525; H01M 10/0562; H01M 2004/027; H01M 2300/008

(57) ABSTRACT

A solid-state lithium-ion battery with long cycle life and ultrafast charging is disclosed. The exceptional cycle life is enabled by an ultra-stable lithium vanadium oxide-based anode material, disordered rock salt Li₃V₂O₅. This anode material has a working potential of ˜0.6 V versus Li/Li⁺, a 3D Li-ion transport pathway, and linear expansion less than 2%. These properties enable rapid lithium transport, eliminate lithium metal plating, and deliver extremely long cycle life. Furthermore, the use of a solid electrolyte such as Li_{5.4}PS_{4.4}Cl_{1.6} provides high-rate capability and a wide operating temperature due to the absence of phase changes or concentration polarization in the electrode. The solid-state lithium-ion battery may be configured to provide over 5,000 cycles to 80% capacity, a 3-minute ultrafast charge time to 80% state of charge, an energy density exceeding 200 W·h/kg and 650 W·h/L, and a wide operating temperature range from −80° C. to 350° C.

### PRIORITY DATA

This non-provisional patent application claims priority to U.S. Provisional Patent App. No. 63/524,256, filed on Jun. 30, 2023, which is hereby incorporated by reference herein.

### FIELD

The present disclosure generally relates to solid-state lithium-ion batteries, and methods of making and using solid-state lithium-ion batteries.

### BACKGROUND

The push to electrify transportation will require the United States electric grid to double in capacity by 2050, assuming 186 million (two-thirds) of light-duty vehicles are converted from combustion engines to electrical energy. This shift will necessitate massive investments in new transmission lines and distribution systems that could reach over $1 trillion by 2050, when all 186 million light-duty electric vehicles (EVs) are in service. The distribution system that connects to the EV charging station—the last mile in electricity delivery, including substations, circuits, switches, and transformers—will incur over 90% of this projected investment. Optimized EV charging and vehicle-to-grid integration can reduce the required distribution investments by ˜70% or $600 billion by minimizing congestion at the distribution level, allowing two-way energy transfers, storing energy closer to the load, and integrating widely distributed renewables.

Rechargeable lithium-ion (Li-ion) batteries that can be safely charged and discharged at high rates are desirable for electrified transportation, portable electronics, grid storage, and other applications. Rechargeable Li-ion batteries have made mobile devices and personal computers a necessity in modern society. While important advancements in battery technology (e.g., energy density and structural stability) have continued, charging speed still requires significant advances for Li-ion batteries. Li-ion batteries may possess high energy density; however, the rate at which the battery can charge is limited by the anode material of the battery.

Graphite has so far been the dominant anode material for rechargeable lithium-ion batteries due to its low cost, high reversibility, and working potential close to lithium metal. These attributes have led to batteries with high specific energy and long cycle life. The current commercial high-energy-density Li-ion batteries based on graphite anodes achieve a high energy density greater than 250 W·h/kg. However, these Li-ion batteries require several hours to charge. Demand for ultrafast charging poses significant challenges for graphite. Under high charging rates, the anode potential in graphite can be driven to below the potential of lithium plating, leading to lithium deposition and the associated losses in lifetime and safety. Decreasing the battery charging time to minutes sacrifices energy and severely reduces cycle life for Li-ion batteries with graphite anodes.

Raising the anode potential slightly can overcome lithium plating. The state-of-the-art commercially available anode for ultra-fast-charge Li-ion batteries is lithium titanate, Li₄Ti₅O₁₂ (LTO). Li₄Ti₅O₁₂ is a generally safe material that can charge in less than 10 minutes for many cycles, but its energy density is less than 90 W·h/kg. Li₄Ti₅O₁₂ has a potential of about 1.5 V vs. Li/Li⁺, which gives a 2.5 V Li-ion battery when paired with a commercial 4 V cathode. The low energy density has limited the application of LTO primarily to buses and utility vehicles.

The potentials for other intercalation anodes, such as LiV_{0.5}Ti_{0.5}S₂, are around 1 V, still far higher than desired. Alloy anodes (e.g., anodes using aluminum alloys) can have ideal potentials of 0.5 V and large capacities, but their cycling stabilities remain questionable even under normal operating conditions—let alone for extremely fast charging. None of the state-of-the-art systems can achieve both high energy density combined with high power density, thus defining a technology gap.

A significant challenge to widespread vehicle-to-grid adoption is the degradation of the battery as a result of high wear from extensive usage of the battery, in frequent discharging (while driving the EV) and charging (while connected to the grid for recharging). Similar challenges exist for heavy-duty vehicles, construction vehicles, two-wheel vehicles, boats, robotics, drones, electric vertical take-off and landing aircraft, and many other commercial applications.

In view of the art, there remains a need for improved Li-ion batteries. What is especially desired is a safe Li-ion battery that can achieve fast charging in less than 10 minutes, has at least 100 W·h/kg energy density, and is capable of operating for at least 1,000 cycles.

### SUMMARY

The present disclosure addresses the aforementioned needs in the art, as will now be summarized and then further described in detail below.

Some variations provide a solid-state lithium-ion battery comprising: an anode layer comprising lithium vanadium oxide, wherein the lithium vanadium oxide has a composition given by LiₐV_{b}O_{c}, wherein a=0.001-10, b=1-3, c=1-9, and a, b, and c are selected to charge-balance the LiₐV_{b}O_{c}, wherein the LiₐV_{b}O_{c} is capable of being reversibly lithiated, and wherein at least some of the LiₐV_{b}O_{c} has a disordered rocksalt structure in the Fm3̅m space group;
a solid electrolyte layer comprising a solid electrolyte; and
a cathode layer comprising a cathode material,
wherein the solid electrolyte layer is interposed between the anode layer and the cathode layer.

In some embodiments, about 0.01 wt % to 100 wt % of the LiₐV_{b}O_{c} has a disordered rocksalt structure in the Fm3̅m space group.

In some embodiments, the LiₐV_{b}O_{c} is selected from the group consisting of Li₃V₂O₅, Li₄V₂O₅, Li₅V₂O₅, LiV₂O₅, Li_{0.001}V₂O₅, Li₂V₂O₅, Li_{0.001}VO₂, LiVO₂, Li₂VO₂, Li_{0.001}VO₃, LiVO₃, Li₂VO₃, Li₃VO₃, Li_{0.001}V₃O₈, LiV₃O₈, Li₂V₃O₈, Li₃V₃O₈, Li_{0.001}V₂O₃, LiV₂O₃, Li₂V₂O₃, Li₃V₂O₃, and combinations thereof.

In some embodiments, the lithium vanadium oxide further contains a dopant M that is chemically or physically contained within the lithium vanadium oxide such that its composition is given by LiₐV_{b}O_{c}M_{d}, wherein d=0.001-3, wherein a, b, c, and d are selected to charge-balance the LiₐV_{b}O_{c}M_{d}, wherein the LiₐV_{b}O_{c}M_{d} is capable of being reversibly lithiated, and wherein at least some of the LiₐV_{b}O_{c}M_{d} has a disordered rocksalt structure in the Fm3̅m space group. About 0.01 wt % to 100 wt % of the LiₐV_{b}O_{c}M_{d} may have a disordered rocksalt structure in the Fm3̅m space group. The dopant M may be selected from the group consisting of Na, K, Be, Mg, Ca, Zn, Fe, Co, Ni, Cu, Ag, Sc, B, Y, Al, La, Si, Ge, Sn, Ti, Zr, Mn, P, Nb, Ta, Cr, Mo, W, Se, N, S, F, Cl, Br, I and combinations thereof.

In various embodiments, the solid electrolyte is selected from the group consisting of oxides, sulfides, phosphates, argyrodites, β-aluminas, LISICON, garnets, NASICON, perovskites, antiperovskites, lithium nitrides, lithium hydrides, lithium phosphidotrielates and phosphidotetrelates, lithium metal halides (e.g., lithium metal chlorides), UPON, lithium thiophosphates, and combinations thereof.

In some embodiments, the solid electrolyte is a sulfur-based superionic conductor, such as a halogen-containing lithium argyrodite. The halogen-containing lithium argyrodite may be selected from Li_{6-ε}PS_{5-ε}X_{1+ε}, wherein −1<ε≤1, and wherein X=F, Cl, Br, I, or a combination thereof. For example, X may be Cl, and 0≤ε≤0.8. In some embodiments, the sulfur-based superionic conductor is selected from the group consisting of Li₂S—P₂S₅, Li₇P₃S₁₁, Li₁₀GeP₂S₁₂, Li₇SiPS₈, Li₃PS₄, Li₁₊₂ₓZn₁₋ₓPS₄ (0≤x<1), and combinations thereof.

In some embodiments, the solid electrolyte is an oxide-based superionic conductor. The oxide-based superionic conductor may be selected from the group consisting of Li—Al₂O₃, Li₇La₃Zr₂O₁₂, Li₂₊₂ₓZn₁₋ₓGeO₄ (0≤x≤1), Li₁₊ₓZr₂SiₓP₃ₓO₁₂ (0<x<3), La_{2/3-x}Li₃ₓTiO₃ (0<x<⅔), LiₓX¹₃X²₂O₁₂ (X¹=La, Nd, Mg, or Ba; X²=Te, Ta, Nb, Zr, or In; and 0<x<7), and combinations thereof.

In some embodiments, the solid electrolyte is a phosphate-based superionic conductor. The phosphate-based superionic conductor may be selected from the group consisting of Li₃PO₄, Li₁₊ₓX¹ₓX²₂₋ₓ(PO₄)₃ (X¹=Al, La, In, or Cr; X²=Ti, Ge, Zr, Hf, or Sn; and 0<x<2), and combinations thereof.

In some embodiments, the solid electrolyte is a nitride-based superionic conductor. The nitride-based superionic conductor may be selected from the group consisting of Li₃N, LiₓPO_{y}N_{z} (0<x≤3; 0<y≤4; and 0<z≤1), and combinations thereof.

In some embodiments, the solid electrolyte is a hydride-based superionic conductor. The hydride-based superionic conductor may be selected from the group consisting of LiBH₄, LiCB₉H₁₀, LiCB₁₁H₁₂, and combinations thereof.

In some embodiments, in which the solid electrolyte is selected from antiperovskites, the antiperovskites are selected from the group consisting of Li₃OCl, Li₃OBr, Li₃OF, Li₃OI, and combinations thereof.

The cathode material may be selected from the group consisting of LiCoO₂, LiMn₂O₄, Li₂MnO₃, LiFePO₄, LiNiₓCo_{y}Al_{z}O₂ (x+y+z=1), LiMnₓNi_{y}O₄ (x+y=2), LiNiₓCo_{y}Mn_{z}O₂ (x+y+z=1), LiFeₓMn_{y}PO₄ (x+y=1), aLiNiₓCo_{y}Mn_{z}O₂·(1−a)Li₂MnO₃ (0<a<1 and x+y+z=1), and combinations thereof, for example.

In some embodiments, the cathode material is the LiNiₓCo_{y}Mn_{z}O₂. The LiNiₓCo_{y}Mn_{z}O₂ may be LiNi_{0.8}Co_{0.1}Mn_{0.1}O₂, for example.

In some solid-state lithium-ion batteries, the solid electrolyte is also contained within the anode layer. In these or other embodiments, the solid electrolyte is also contained within the cathode layer.

In certain embodiments, the anode layer, the cathode layer, or the solid electrolyte layer further contains a noble metal in neutral or ionic form. The noble metal is typically present only in trace concentrations. The noble metal may be selected from the group consisting of Au, Ag, Pt, Rh, Pd, Ru, Os, Ir, and combinations thereof.

The anode layer may further contain a second anode material selected from the group consisting of silicon, silicon oxide, graphite, hard carbon, soft carbon, silicon-carbon composites, aluminum, magnesium, zinc, tin, tin oxide, and combinations thereof.

When the anode layer contains carbon as an additive, the anode carbon additive may be in sp form, sp² form, and/or sp³ form. The anode carbon additive may be graphite, graphene, carbon nanotubes, carbon fibers, ultrafine carbon, activated carbon, carbon black, nanodiamonds, hard carbon, soft carbon, or a combination thereof, for example.

The cathode layer may further contain a cathode carbon additive in sp form, sp² form, and/or sp³ form. The cathode carbon additive may be graphite, graphene, carbon nanotubes, carbon fibers, ultrafine carbon, activated carbon, carbon black, nanodiamonds, hard carbon, soft carbon, or a combination thereof. The cathode carbon additive may be the same type of carbon as the anode carbon additive, or they may be different types of carbon.

Typically, the cathode layer is disposed on a cathode current collector (e.g., Al foil), and the anode layer is disposed on an anode current collector (e.g., Cu foil).

In some embodiments, the solid-state lithium-ion battery contains a plurality of anode layers, a plurality of solid electrolyte layers, and a plurality of cathode layers.

In some embodiments, the solid-state lithium-ion battery is capable of maintaining at least 80% battery capacity after performing 1,000, 5,000, 10,000, 15,000, or 20,000 cycles.

In some embodiments, the solid-state lithium-ion battery is capable of charging to 100% state of charge in 3 minutes or less.

In some embodiments, the solid-state lithium-ion battery has an energy density of at least 200 W·h/kg.

In some embodiments, the solid-state lithium-ion battery has an energy density of at least 650 W·h/L.

In some embodiments, the solid-state lithium-ion battery is capable of operating in a temperature range from about −80° C. to about 350° C.

In some embodiments, the solid-state lithium-ion battery does not undergo lithium metal plating during operation.

In some embodiments, the solid-state lithium-ion battery is contained within a battery module/pack comprising a plurality of batteries. The battery module/pack may be contained within an electric vehicle. The electric vehicle may be an electric automobile, an electric truck, an electric bus, an electric locomotive, or an electric airplane, for example.

In some embodiments, the solid-state lithium-ion battery is contained within a portable device.

In some embodiments, the solid-state lithium-ion battery is contained within a smart device.

In some embodiments, the solid-state lithium-ion battery is contained within an emergency power backup system.

In some embodiments, the solid-state lithium-ion battery is contained within a solar-power electricity storage system.

Other variations of the invention provide a method of manufacturing a cell, the method comprising:
(a) casting an anode material, an anode carbon additive, and a solid electrolyte onto a first substrate to form an anode, wherein the anode material comprises a plurality of anode-material particles, wherein the anode-material particles comprise an internal phase containing LiₓV_{y}O_{z}, wherein x=0-10, y=1-3, z=1-9, and x, y, and z are selected to charge-balance the LiₓV_{y}O_{z};
(b) pressing a Li foil onto the anode, to form a pressed anode;
(c) casting a cathode material, a cathode carbon additive, and the solid electrolyte onto a second substrate, to form a cathode;
(d) stacking a solid electrolyte layer onto the pressed anode, wherein the solid electrolyte layer comprises the solid electrolyte;
(e) stacking the cathode onto the solid electrolyte layer;
(f) surrounding multiple layers of the anode, multiple layers of the solid electrolyte layer, and multiple layers of the cathode with a packet foil, to form a cell; and
(g) converting the pressed anode into a lithiated anode comprising LiₐV_{b}O_{c}, wherein a=0.001-10, b=1-3, c=1-9, and a, b, and c are selected to charge-balance the LiₐV_{b}O_{c}, wherein the LiₐV_{b}O_{c} is capable of being reversibly lithiated, and wherein at least some of the LiₐV_{b}O_{c} has a disordered rocksalt structure in the Fm3̅m space group.

Non-integer values of a, b, and c are possible, as long as the LiₐV_{b}O_{c} is charge-balanced. In some embodiments of LiₐV_{b}O_{c}, a=0.001-10. In various embodiments of LiₐV_{b}O_{c}, a is about, at least about, or at most about 0.001, 0.002, 0.005, 0.01, 0.02, 0.03, 0.04, 0.05, 0.1, 0.2, 0.3, 0.4, 0.5, 0.6, 0.7, 0.8, 0.9. 1.0, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, 2.95, 3.0, 3.05, 3.1, 3.2, 3.3, 3.4, 3.5, 3.6, 3.7, 3.8, 3.9, 4.0, 4.1, 4.2, 4.3, 4.4, 4.5, 4.6, 4.7, 4.8, 4.9, 5.0, 5.5, 6.0, 6.5, 7.0, 7.5, 8.0, 8.5, 9.0, 9.5, or 10.0, including any intervening ranges.

In some embodiments of LiₐV_{b}O_{c}, b=1.5-3.0. In various embodiments of LiₐV_{b}O_{c}, b is about, at least about, or at most about 1.0, 1.1, 1.2, 1.3, 1.4, 1.5, 1.6, 1.7, 1.8, 1.9, 1.95, 2.0, 2.05, 2.1, 2.2, 2.3, 2.4, 2.5, 2.6, 2.7, 2.8, 2.9, or 3.0, including any intervening ranges.

In some embodiments of LiₐV_{b}O_{c}, c=3-9. In various embodiments of LiₐV_{b}O_{c}, c is about, at least about, or at most about 1.0, 1.5, 2.0, 2.5, 3.0, 3.5, 4.0, 4.5, 4.6, 4.7, 4.8, 4.9, 4.95, 5.0, 5.05, 5.1, 5.2, 5.3, 5.4, 5.5, 6.0, 6.5, 7.0, 7.5, 8.0, 8.5, or 9.0, including any intervening ranges.

In some methods, the anode-material particles further contain a dopant M that is chemically or physically contained within the anode-material particles with composition given by LiₐV_{b}O_{c}M_{d}, wherein d=0.001-3, wherein a, b, c, and d are selected to charge-balance the LiₐV_{b}O_{c}M_{d}, wherein the LiₐV_{b}O_{c}M_{d} is capable of being reversibly lithiated, and wherein at least some of the LiₐV_{b}O_{c}M_{d} has a disordered rocksalt structure in the Fm3̅m space group.

In some methods, the anode material, the anode carbon additive, and the solid electrolyte are coated on both sides of a layer of the first substrate; and the cathode material, the cathode carbon additive, and the solid electrolyte are coated on both sides of a layer of the second substrate.

In some methods, step (a) utilizes a casting pressure selected from about 10 kPa to about 250 MPa.

In some methods, step (b) utilizes a pressing pressure selected from about 10 kPa to about 100 MPa.

In some methods, the first substrate is a copper foil with a thickness from about 1 micron to about 100 microns.

In some methods, the second substrate is an aluminum foil with a thickness from about 1 micron to about 100 microns.

In some methods, the anode has an anode material loading selected from about 20 wt % to about 100 wt %.

In some methods, the anode has an anode material areal loading selected from about 0.2 mg/cm² to about 50 mg/cm² on at least one side of the anode.

In some methods, the anode has an anode material areal capacity selected from about 0.05 mA·h/cm² to about 10 mA·h/cm² on at least one side of the anode.

Other variations provide a method of manufacturing a cell, the method comprising:
(a) casting an anode material, an anode carbon additive, and a solid electrolyte onto a first substrate to form an anode, wherein the anode material comprises a plurality of anode-material particles, wherein the anode-material particles comprise an internal phase containing LiₐV_{b}O_{c}, wherein a=0.001-10, b=1-3, c=1-9, and a, b, and c are selected to charge-balance the LiₐV_{b}O_{c};
(b) casting a cathode material, a cathode carbon additive, and the solid electrolyte onto a second substrate, to form a cathode;
(c) stacking a solid electrolyte layer onto the anode, wherein the solid electrolyte layer comprises the solid electrolyte;
(d) stacking the cathode onto the solid electrolyte layer; and
(e) surrounding multiple layers of the anode, multiple layers of the solid electrolyte layer, and multiple layers of the cathode with a packet foil, to form a cell,
wherein the LiₐV_{b}O_{c} is capable of being reversibly lithiated, and wherein at least some of the LiₐV_{b}O_{c} has a disordered rocksalt structure in the Fm3̅m space group.

The anode-material particles may further contain a dopant M that is chemically or physically contained within the anode-material particles with composition given by LiₐV_{b}O_{c}M_{d}, wherein d=0.001-3, wherein a, b, c, and d are selected to charge-balance the LiₐV_{b}O_{c}M_{d}, wherein the LiₐV_{b}O_{c}M_{d} is capable of being reversibly lithiated, and wherein at least some of the LiₐV_{b}O_{c}M_{d} has a disordered rocksalt structure in the Fm3̅m space group.

The anode material, the anode carbon additive, and the solid electrolyte may be coated on both sides of a layer of the first substrate. Similarly, the cathode material, the cathode carbon additive, and the solid electrolyte may be coated on both sides of a layer of the second substrate.

Step (a) may utilize a casting pressure selected from about 10 kPa to about 250 MPa, for example.

The first substrate may be a copper foil with a thickness from about 1 micron to about 100 microns. The second substrate may be an aluminum foil with a thickness from about 1 micron to about 100 microns.

The fabricated anode may have an anode material loading selected from about 20 wt % to about 100 wt %.

The fabricated anode may have an anode material areal loading selected from about 0.2 mg/cm² to about 50 mg/cm² on at least one side of the anode.

The fabricated anode may have an anode material areal capacity selected from about 0.05 mA·h/cm² to about 10 mA·h/cm² on at least one side of the anode.

Still other variations provide a method of manufacturing a cell, the method comprising:
(a) casting an anode material, an anode carbon additive, a solid electrolyte, and a Li metal onto a first substrate to form an anode, wherein the anode material comprises a plurality of anode-material particles, wherein the anode-material particles comprise an internal phase containing LiₓV_{y}O_{z}, wherein x=0-10, y=1-3, z=1-9, and x, y, and z are selected to charge-balance the LiₓV_{y}O_{z};
(b) casting a cathode material, a cathode carbon additive, and the solid electrolyte onto a second substrate, to form a cathode;
(c) stacking a solid electrolyte layer onto the anode, wherein the solid electrolyte layer comprises the solid electrolyte;
(d) stacking the cathode onto the solid electrolyte layer;
(e) surrounding multiple layers of the anode, multiple layers of the solid electrolyte layer, and multiple layers of the cathode with a packet foil, to form a cell; and
(f) converting the anode into a lithiated anode comprising LiₐV_{b}O_{c}, wherein a=0.001-10, b=1-3, c=1-9, and a, b, and c are selected to charge-balance the LiₐV_{b}O_{c}, wherein the LiₐV_{b}O_{c} is capable of being reversibly lithiated, and wherein at least some of the LiₐV_{b}O_{c} has a disordered rocksalt structure in the Fm3̅m space group.

In some methods using Li metal in step (a) the Li metal is selected from the group consisting of a Li metal powder, a Li metal ingot, a Li metal foil, and combinations thereof.

In some methods using Li metal in step (a), the anode-material particles further contain a dopant M that is chemically or physically contained within the anode-material particles with composition given by LiₐV_{b}O_{c}M_{d}, wherein d=0.001-3, wherein a, b, c, and d are selected to charge-balance the LiₐV_{b}O_{c}M_{d}, wherein the LiₐV_{b}O_{c}M_{d} is capable of being reversibly lithiated, and wherein at least some of the LiₐV_{b}O_{c}M_{d} has a disordered rocksalt structure in the Fm3̅m space group.

In some methods using Li metal in step (a), the anode material, the anode carbon additive, and the solid electrolyte are coated on both sides of a layer of the first substrate.

In some methods using Li metal in step (a), the cathode material, the cathode carbon additive, and the solid electrolyte are coated on both sides of a layer of the second substrate.

In some methods using Li metal in step (a), that step utilizes a casting pressure selected from about 10 kPa to about 250 MPa.

In some methods using Li metal in step (a), the first substrate is a copper foil with a thickness from about 1 micron to about 100 microns, and/or the second substrate is an aluminum foil with a thickness from about 1 micron to about 100 microns.

In some methods using Li metal in step (a), the anode has an anode material loading selected from about 20 wt % to about 100 wt %.

In some methods using Li metal in step (a), the anode has an anode material areal loading selected from about 0.2 mg/cm² to about 50 mg/cm² on at least one side of the anode.

In some methods using Li metal in step (a), the anode has an anode material areal capacity selected from about 0.05 mA·h/cm² to about 10 mA·h/cm² on at least one side of the anode.

Yet other variations of the invention provide a method of manufacturing a cell, the method comprising:
(a) casting an anode material, an anode carbon additive, and a solid electrolyte onto a first substrate to form an anode, wherein the anode material comprises a plurality of anode-material particles, wherein the anode-material particles comprise an internal phase containing LiₓV_{y}O_{z}, wherein x=0-10, y=1-3, z=1-9, and x, y, and z are selected to charge-balance the LiₓV_{y}O_{z};
(b) casting a cathode material, a cathode carbon additive, the solid electrolyte, and a lithium-containing compound onto a second substrate, to form a cathode, wherein the lithium-containing compound is chemically distinct from the cathode material;
(c) stacking a solid electrolyte layer onto the anode;
(d) stacking the cathode onto the solid electrolyte layer;
(e) surrounding multiple layers of the anode, multiple layers of the solid electrolyte layer, and multiple layers of the cathode with a packet foil, to form a cell; and
(f) decomposing the lithium-containing compound to add lithium to the anode-material particles, thereby converting the anode into a lithiated anode comprising LiₐV_{b}O_{c}, wherein a=0.001-10, b=1-3, c=1-9, and a, b, and c are selected to charge-balance the LiₐV_{b}O_{c}, wherein the LiₐV_{b}O_{c} is capable of being reversibly lithiated, and wherein at least some of the LiₐV_{b}O_{c} has a disordered rocksalt structure in the Fm3̅m space group.

In some methods using decomposition of a lithium-containing compound in step (f), the anode-material particles further contain a dopant M that is chemically or physically contained within the anode-material particles with composition given by LiₐV_{b}O_{c}M_{d}, wherein d=0.001-3, wherein a, b, c, and d are selected to charge-balance the LiₐV_{b}O_{c}M_{d}, wherein the LiₐV_{b}O_{c}M_{d} is capable of being reversibly lithiated, and wherein at least some of the LiₐV_{b}O_{c}M_{d} has a disordered rocksalt structure in the Fm3̅m space group.

In some methods using decomposition of a lithium-containing compound in step (f), the lithium-containing compound is selected from the group consisting of lithium oxide, lithium hydride, lithium hydroxide, lithium hydroperoxide, lithium peroxide, lithium nitride, lithium carbonate, lithium bicarbonate, lithium sulfide, lithium sulfate, lithium squarate, lithium oxalate, lithium ketomalonate, lithium di-ketosuccinate, and combinations thereof. In certain embodiments, the lithium-containing compound is lithium oxide (Li₂O) and/or lithium nitride (Li₃N).

In some methods using decomposition of a lithium-containing compound in step (f), the anode material, the anode carbon additive, and the solid electrolyte are coated on both sides of a layer of the first substrate. Similarly, the cathode material, the cathode carbon additive, and the solid electrolyte may be coated on both sides of a layer of the second substrate.

In some methods using decomposition of a lithium-containing compound in step (f), step (a) utilizes a casting pressure selected from about 10 kPa to about 250 MPa.

In some methods using decomposition of a lithium-containing compound in step (f), the first substrate is a copper foil with a thickness from about 1 micron to about 100 microns.

In some methods using decomposition of a lithium-containing compound in step (f), the second substrate is an aluminum foil with a thickness from about 1 micron to about 100 microns.

In some methods using decomposition of a lithium-containing compound in step (f), the anode has an anode material loading selected from about 20 wt % to about 100 wt %.

In some methods using decomposition of a lithium-containing compound in step (f), the anode has an anode material areal loading selected from about 0.2 mg/cm² to about 50 mg/cm² on at least one side of the anode.

In some methods using decomposition of a lithium-containing compound in step (f), the anode has an anode material areal capacity selected from about 0.05 mA·h/cm² to about 10 mA·h/cm² on at least one side of the anode.

In some methods using decomposition of a lithium-containing compound in step (f), that step is carried out prior to charging of the cell. In other embodiments, step (f) is carried out during charging of the cell, such as when charging the cell for the first time. In certain embodiments, step (f) is carried out both prior to charging of the cell as well as during charging.

### BRIEF DESCRIPTION OF THE DRAWINGS

FIG. 1 is a schematic illustration of an exemplary solid-state lithium-ion battery.

FIGS. 2A and 2B show the performance of an all-solid-state Li∥DRS-LVO cell using a Li₃PS₄ solid electrolyte, in Example 2.

FIG. 2A shows voltage profiles of DRS-LVO at room temperature (about 25° C.) under different rates.

FIG. 2B shows voltage profiles of DRS-LVO at 60° C. at different rates.

FIG. 3A shows voltage profiles of DRS-LVO at 60° C. under different rates, demonstrating the performance of an all-solid-state Li∥DRS-LVO cell using a Li₆PS₅Cl solid electrolyte, in Example 3.

FIG. 3B shows the cycling performance of the DRS-LVO at 1C. FIG. 3C shows voltage profiles of DRS-LVO at 1C over the course of 200 cycles, in Example 3.

FIG. 4A shows voltage profiles of DRS-LVO at 60° C. under different rates, demonstrating the performance of an all-solid-state Li∥DRS-LVO cell using a Li₆PS₅Cl solid electrolyte, in Example 4.

FIG. 4B shows cycling performance of DRS-LVO at 1C (Example 4).

FIG. 4C shows voltage profiles of DRS-LVO at 1C over the course of 200 cycles, in Example 4.

FIG. 5A shows voltage profiles of DRS-LVO at room temperature under different rates, demonstrating the performance of an all-solid-state Li∥DRS-LVO cell using a Cl-rich lithium argyrodite electrolyte Li_{5.4}PS_{4.4}Cl_{1.6}, in Example 5.

FIG. 5B shows cycling performance of DRS-LVO at 1C (Example 5).

FIG. 5C shows voltage profiles of DRS-LVO at 1C over the course of 150 cycles, in Example 5.

FIG. 6 shows that a DRS-LVO∥NMC811 solid-state full cell using a Cl-rich lithium argyrodite electrolyte, Li_{5.4}PS_{4.4}Cl_{1.6}, operated at a temperature of 60° C., exhibits an average voltage of about 3.3 V.

### DETAILED DESCRIPTION OF EMBODIMENTS

The principles, compositions, systems, and methods of the present disclosure will be described in detail by reference to various non-limiting embodiments of the technology.

This description will enable one skilled in the art to make and use the technology, and it describes several embodiments, adaptations, variations, alternatives, and uses of the technology. These and other embodiments, features, and advantages of the present technology will become more apparent to those skilled in the art when taken with reference to the following detailed description in conjunction with the accompanying drawings.

Unless defined otherwise, all technical and scientific terms used herein have the same meaning as is commonly understood by one of ordinary skill in the art to which this technology belongs.

Unless otherwise indicated, all numbers expressing conditions, concentrations, dimensions, and so forth used in the specification and claims are to be understood as being modified in all instances by the term “about.” Accordingly, unless indicated to the contrary, the numerical parameters set forth in the following specification and attached claims are approximations that may vary depending at least upon a specific analytical technique.

The term “comprising,” which is synonymous with “including,” “containing,” or “characterized by” is inclusive or open-ended and does not exclude additional, unrecited elements or method steps. “Comprising” is a term of art used in claim language which means that the named claim elements are essential, but other claim elements may be added and still form a construct within the scope of the claim.

As used herein, the phrase “consisting of” excludes any element, step, or ingredient not specified in the claim. When the phrase “consists of” (or variations thereof) appears in a clause of the body of a claim, rather than immediately following the preamble, it limits only the element set forth in that clause; other elements are not excluded from the claim as a whole. As used herein, the phrase “consisting essentially of” limits the scope of a claim to the specified elements or method steps, plus those that do not materially affect the basis and novel characteristic(s) of the claimed subject matter.

With respect to the terms “comprising” (synonymously, “including”), “consisting of,” and “consisting essentially of,” where one of these three terms is used herein, the presently disclosed and claimed subject matter may include the use of either of the other two terms, except when used in Markush groups. Thus in some embodiments not otherwise explicitly recited, any instance of “comprising” may be replaced by “consisting of” or, alternatively, by “consisting essentially of” The term “including” should be read as meaning “including, without limitation” or the like; the term “example” is used to provide exemplary instances of the item in discussion, not an exhaustive or limiting list thereof.

Adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this patent application refers to technologies that would be apparent or known to one of ordinary skill in the art, such technologies encompass those apparent or known to the skilled artisan now or at any time in the future.

In this specification, hypotheses and theories are disclosed, it being understood that the present invention is not limited to the proposed hypotheses and theories.

In this specification, with respect to a concentration of a component within a composition, a percentage is in reference to weight percent (wt %), unless indicated otherwise.

As used in this specification and the appended claims, the singular forms “a,” “an,” and “the” include plural referents unless the context clearly indicates otherwise. The terms “a” or “an” should be read as meaning “at least one,” “one or more” or the like. The presence of broadening words and phrases such as “one or more,” “at least,” “but not limited to” or other like phrases in some instances shall not be read to mean that the narrower case is intended or required in instances where such broadening phrases may be absent.

The present invention provides a solid-state lithium-ion battery with >20,000 cycle life and ultrafast charging. The disclosed solid-state lithium-ion battery enables full vehicle-to-grid (V2G) integration to lower the cost of electric vehicle (EV) ownership, ensure grid stability with the forthcoming massive EV transition, and further increase renewable-energy penetration into society. The exceptional cycle life is enabled by an ultra-stable lithium vanadium oxide (LVO)-based anode material, preferably disordered rock salt lithium vanadium oxide (“DRS-LVO”), e.g. disordered rock salt Li₃V₂O₅.

The DRS-LVO anode material has a working potential of ˜0.6 V vs Li/Li⁺, a three-dimensional Li-transport pathway, and a linear expansion less than 2%. These properties make it essentially immune to lithium metal plating, enable rapid lithium transport, and deliver extremely long cycle life. In addition, in this disclosure, the use of a solid electrolyte (SE) allows for high-rate capability, a wider operating temperature due to the absence of concentration polarization in the electrode, and the absence of a phase change of the electrolyte—such as freezing at cold temperatures, or vaporization of liquid electrolyte at hot temperatures.

In some variations, the performance of a DRS-LVO-based solid-state lithium-ion battery is outstanding: (i) >20,000 cycles to 80% capacity; (ii) a 3-minute ultrafast charge time to 80% state-of-charge (SOC); (iii) an energy density>200 W·h/kg and >650 W·h/L; and (iv) an operating temperature range of about −80° C. (193.15 K) to about 350° C. (623.15 K), such as about −60° C. (213.15 K) to about 150° C. (423.15 K), or about −40° C. (233.15 K) to about 120° C. (393.15 K).

As mentioned in the Background, an important challenge to widespread V2G adoption is the degradation of the battery as a result of high wear from increased use during driving and grid services. For state-of-the-art Li-ion technology, this degradation is largely determined by the graphite anode, particularly under fast charging rates. The present invention is predicated, in part, on the replacement of graphite with DRS-LVO to effectively eliminate the battery-life limitation and enable universal V2G adoption. In addition, a solid electrolyte greatly widens the battery operating temperature to (i) enhance battery-pack energy density, (ii) increase rate capability to reduce charging time, and (iii) enhance safety by eliminating volatile liquids and gels. The disclosed battery can be used in a significant fraction of the expected >11 TW·h of EV energy storage (186 million EVs at 60 kW·h per EV) with full V2G capabilities. V2G could form the world's largest virtual power plant, increase grid resiliency, decarbonize transportation, integrate renewable energy in an efficient way, and create new revenue streams for EV owners to accelerate the transition to fully electric transportation.

In some variations, novel DRS-LVO is paired with superionic conductors such as halogen-rich lithium argyrodite and high-energy cathodes. Many specific compositions are disclosed herein.

In some embodiments, the invention provides an ultralong-cycle-life solid-state battery containing a DRS-LVO-based anode, a halogen-rich lithium argyrodite solid electrolyte, and a nickel-rich NMC (nickel-manganese-cobalt) cathode. The breakthrough in ultralong-cycle-life solid-state batteries is made possible, at least in part, by the use of a novel anode material based on DRS-LVO, which has a disordered rocksalt structure with in the Fm3̅m space group.

A DRS-LVO anode has many benefits. First, DRS-LVO operates at an average potential of 0.6 V vs. Li/Li⁺, almost 1 V lower than state-of-the-art Li₄Ti₅O₁₂ (LTO) fast-charge anodes, but well above the Li-metal plating region, allowing ultrafast charge capability without sacrificing safety. The elevated potential is higher than Li-metal anodes or Si anodes, resulting in excellent stability with solid electrolytes. Second, the DRS-LVO can reversibly host two Li ions, resulting in a high specific capacity of 260 mA·h/g (over 50% vs. LTO anode), making the solid-state battery pack energy density equivalent to current high-energy Li-ion chemistries. Third, the low Li-ion diffusion energy barriers of DRS-LVO enable its outstanding rate performance. At 20 A/g equivalent to a 20-second charge, the discharge capacity of DRS-LVO is 109 mA·h/g, or 41% of its full capacity. Fourth, DRS-LVO has a linear expansion less than 2%, which is significantly less than the linear expansion of graphite anodes (10-12% of expansion along the c axis). The low linear expansion enables excellent material stability to 35,000 lithium insertion/removal cycles in a liquid-electrolyte-based battery, and is ideal for solid-state batteries in which volume change is even more critical than in batteries with a liquid electrolyte.

A solid-state battery to achieve ultrafast charging is heretofore counterintuitive, since it is well-known that mass-transport rates are higher in a liquid phase compared to a solid phase. However, the present inventors have recognized, using inventive skill, the rate-limiting steps during battery operation. By moving from a liquid electrolyte to a solid electrolyte, several technical advantages may be achieved:

1. In a solid electrolyte, there may be little or no concentration polarization. Concentration polarization in electrolytes refers to the additional voltage drop (or “internal resistance”) across the electrolyte associated with ion concentration gradients, which exists in addition to the Ohmic voltage drop associated with the mean conductivity.

2. In solid-state batteries, there is an absence of a de-solvation process, because there is no electrolyte solvent.

3. The Li-ion concentration in the solid electrolyte (e.g., 10 to 50 mol/L) is much higher, such as an order of magnitude or more, than that in the conventional liquid electrolytes (e.g., 1-3 mol/L). Depletion of lithium ions in the electrolyte at the anode composite has been considered as the key reason for the limited utilization of graphite anode at a high rate.

4. The ionic conductivity of solid electrolytes is higher than that of liquid electrolytes and with a much higher Li transference number. SE conductivity follows an Arrhenius rate with temperature. The result can be significantly enhanced kinetics of solid-state batteries over liquid-electrolyte batteries.

In some embodiments, a Ni-rich NMC material is selected as the cathode because of its high capacity and high rate capability. For example, NMC811 (LiNi_{0.8}Mn_{0.1}Co_{0.1}O₂) shows >203 mA·h/g at 0.1C between 3.0 V and 4.3 V. Moreover, NMC811 possesses high electronic conductivity of 1.7×10⁻⁵ S/cm with a high Li diffusivity of 10⁻⁸ to 10⁻⁹ cm²/s, enabling its high rate capability. Excellent cycling stability of NMC811 in a solid-state battery at a very high rate has also been demonstrated.

Some variations provide a solid-state lithium-ion battery comprising:
an anode layer comprising lithium vanadium oxide, wherein the lithium vanadium oxide has a composition given by LiₐV_{b}O_{c}, wherein a=0.001-10, b=1-3, c=1-9, and a, b, and c are selected to charge-balance the LiₐV_{b}O_{c}, wherein the LiₐV_{b}O_{c} is capable of being reversibly lithiated, and wherein at least some of the LiₐV_{b}O_{c} has a disordered rocksalt structure in the Fm3̅m space group;
a solid electrolyte layer comprising a solid electrolyte; and
a cathode layer comprising a cathode material, wherein the solid electrolyte layer is interposed between the anode layer and the cathode layer.

In some embodiments, about 0.01 wt % to 100 wt % of the LiₐV_{b}O_{c} has a disordered rocksalt structure in the Fm3̅m space group. Preferably, at least 10 wt % of the LiₐV_{b}O_{c} has a disordered rocksalt structure in the Fm3̅m space group. More preferably, at least 50 wt % of the LiₐV_{b}O_{c} has a disordered rocksalt structure in the Fm3̅m space group. Even more preferably, at least 90 wt % of the LiₐV_{b}O_{c} has a disordered rocksalt structure in the Fm3̅m space group. Most preferably, essentially all of the LiₐV_{b}O_{c} has a disordered rocksalt structure in the Fm3̅m space group. In various embodiments, at least 10 wt %, 15 wt %, 20 wt %, 25 wt %, 30 wt %, 35 wt %, 40 wt %, 45 wt %, 50 wt %, 55 wt %, 60 wt %, 65 wt %, 70 wt %, 75 wt %, 80 wt %, 85 wt %, 90 wt %, 91 wt %, 92 wt %, 93 wt %, 94 wt %, 95 wt %, 96 wt %, 97 wt %, 98 wt %, 99 wt %, 99.5 wt %, or 99.9 wt % (such as 100 wt %) of the LiₐV_{b}O_{c} has a disordered rocksalt structure in the Fm3̅m space group.

A disordered rocksalt structure is described by Liu et al., “A disordered rock salt anode for fast-charging lithium-ion batteries”, Nature volume 585, pages 63-67 (2020), which is hereby incorporated by reference. The disordered rocksalt crystal structure can be indexed in the Fm3̅m space group, with a cubic lattice parameter a=4.095 Å. The disordered rocksalt crystal structure of LiₐV_{b}O_{c} is a crystal lattice containing a disordered (rather than strictly periodic) arrangement of lithium (Li) and transition metal (V) on the cation lattice. The oxygen atoms are close packed to form the face-centered-cubic structure. The majority of the lithium (Li) and transition metal (V) locate at octahedral sites formed by oxygen. Lithium (Li) can be also distributed in tetrahedral sites formed by oxygen.

A disordered rocksalt crystal structure contrasts with an ordered rocksalt crystal structure, such as with NaCl, in which the sodium and chloride ions form regular, orderly structures. In a disordered rocksalt crystal structure, the precise sites for the metal ions vary, but there is still an overall crystal structure. This specification hereby incorporates by reference International Tables for Crystallography Volume A: Space-group symmetry, Second online edition, edited by Aroyo, 2016.

A disordered rocksalt crystal structure also contrasts with an disordered amorphous structure that lacks a crystalline lattice. For example, when LiₐV_{b}O_{c} is nominally Li₃V₂O₅, an amorphous structure would mean that the Li, V, and O atoms are randomly placed in the material, randomly bonded with each other, and do not form a crystal. Crystalline solids have well-defined edges and faces, diffract X-rays, and tend to have sharp melting points. In contrast, amorphous solids have irregular or curved surfaces, do not give well-resolved X-ray diffraction patterns, and melt over a wide range of temperatures. In this invention, the LiₐV_{b}O_{c} is preferably crystalline, or has a crystallinity of at least 80%, at least 85%, at least 90%, at least 95%, at least 99%, or 100%. LiₐV_{b}O_{c} with a crystallinity of at least 80% is referred to herein as crystalline LVO, or c-LVO. LVO crystallinity may be measured using X-ray diffraction.

A LiₐV_{b}O_{c} precursor that does not contain any lithium typically, vanadium pentoxide, V₂O₅—may itself be crystalline or amorphous. In principle, a disordered rocksalt structure does not become possible until there is at least one lithium atom inserted into V₂O₅ (i.e., a>0 in LiₐV_{b}O_{c}). During lithiation, as the value of a increases, the rocksalt structure is preferably maintained, even to very high values of a, such as 4, 5, or even greater. For example, in preferred embodiments, the disordered rocksalt structure is maintained through conversion of Li₃V₂O₅ to Li₄V₂O₅ or Li₅V₂O₅. During lithiation, following the initial formation of a disordered rocksalt structure upon the introduction of lithium atoms, there may be a further increase in the fraction of the LiₐV_{b}O_{c} that has a disordered rocksalt crystal structure. In other embodiments, the fraction of the LiₐV_{b}O_{c} that has a disordered rocksalt crystal structure stays relatively constant as the degree of lithiation (the value of a) increases. In certain embodiments, at the first discharge, the LiₐV_{b}O_{c} may exhibit a superstructure of the rocksalt lattice which disappears upon further cycling. The disappearance of the superstructure does not affect the disordered rocksalt structure and electrochemical performance.

The LiₐV_{b}O_{c} may be present in a non-lithiated state, wherein a=0 in the LiₐV_{b}O_{c}. During use of the anode material, and potentially prior to use of the anode material, the LiₐV_{b}O_{c} is present in a lithiated state, wherein a>0 in the LiₐV_{b}O_{c}.

In some embodiments, the LiₐV_{b}O_{c} is selected from the group consisting of Li₃V₂O₅, Li₄V₂O₅, Li₅V₂O₅, LiV₂O₅, Li_{0.001}V₂O₅, Li₂V₂O₅, Li_{0.001}VO₂, LiVO₂, Li₂VO₂, Li_{0.001}VO₃, LiVO₃, Li₂VO₃, Li₃VO₃, Li_{0.001}V₃O₈, LiV₃O₈, Li₂V₃O₈, Li₃V₃O₈, Li_{0.001}V₂O₃, LiV₂O₃, Li₂V₂O₃, Li₃V₂O₃, and combinations thereof.

The LiₐV_{b}O_{c} may have a density of about 1.5 g/cm³ to about 5.5 g/cm³. In various embodiments, the LiₐV_{b}O_{c} has a density of about, at least about, or at most about 1.5, 1.6, 1.7, 1.8, 1.9, 2.0, 2.1, 2.2, 2.3, 2.4, 2.5, 2.6, 2.7, 2.8, 2.9, 3.0, 3.1, 3.2, 3.3, 3.35, 3.4, 3.5, 3.6, 3.7, 3.8, 3.9, 4.0, 4.1, 4.2, 4.3, 4.4, 4.5, 4.6, 4.7, 4.8, 4.9, 5.0, 5.1, 5.2, 5.3, 5.4, or 5.5 g/cm³, including any intervening ranges.

The anode material may have an anode-material volumetric porosity selected from about 5% to about 80%, for example. In various embodiments, the anode material has an anode-material volumetric porosity of about, at least about, or at most about 5%, 10%, 15%, 20%, 25%, 30%, 40%, 50%, 60%, 70%, or 80%, including any intervening ranges.

In some embodiments, the lithium vanadium oxide further contains a dopant M that is chemically or physically contained within the lithium vanadium oxide such that its composition is given by LiₐV_{b}O_{c}M_{d}, wherein a=0.001-10, b=1-3, c=1-9, and d=0.001-3, wherein a, b, c, and d are selected to charge-balance the LiₐV_{b}O_{c}M_{d}, and wherein the LiₐV_{b}O_{c}M_{d} is capable of being reversibly lithiated. The formula LiₐV_{b}O_{c}M_{d} is a stoichiometric convenience and does not necessarily mean that the dopant M is chemically bonded with any other species present.

The dopant M may be selected from the group consisting of Na, K, Be, Mg, Ca, Zn, Fe, Co, Ni, Cu, Ag, Sc, B, Y, Al, La, Si, Ge, Sn, Ti, Zr, Mn, P, Nb, Ta, Cr, Mo, W, Se, N, S, F, Cl, Br, I, and combinations thereof, for example. The dopants may include one or more monovalent, divalent, trivalent, tetravalent, pentavalent, or hexavalent dopants. Multiple dopants may be present in LiₐV_{b}O_{c}M_{d}, in which case each dopant in the empirical formula may have d=0.1-3.

Dopants may be used to modify the properties of the lithium vanadium oxide. For example, dopants may be used to adjust lithiation, delithiation, or other kinetics; lithiation capacity; anode stability; lithiation-delithiation potential; anode material electronic conductivity; lithium-ion diffusivity in anode material crystal structures; thermal properties; densities; and/or other factors.

The doped composition may have a disordered rocksalt structure. The disordered rocksalt crystal lattice may or may not incorporate the dopant elements. That is, when there is a dopant M, in some embodiments, the disordered rocksalt crystal structure of LiₐV_{b}O_{c}M_{d} is a crystal lattice containing a disordered arrangement of Li atoms, V atoms, and M atoms on the cation lattice site. Alternatively, or additionally, the dopant M may be in a different position than within the cation lattice of the disordered rocksalt crystal structure, such as randomly placed, or in a different crystalline lattice governing the relationship of M with other atoms, potentially superimposed on the disordered rocksalt crystal structure. In certain embodiments, the presence of a dopant M reduces the optimal amount of vanadium (the value of b) in the disordered rocksalt anode material. In certain embodiments, the presence of a dopant M reduces the optimal amount of lithium (the value of a) in the disordered rocksalt anode material. In other certain embodiments, the presence of a non-metal dopant M (e.g., M=N, S, F, Cl, Br, or I) reduces the optimal amount of oxygen (the value of c) in the disordered rocksalt anode material.

In preferred embodiments using a dopant, at least some of the LiₐV_{b}O_{c}M_{d} has a disordered rocksalt structure in the Fm3̅m space group. About 0.01 wt % to 100 wt % of the LiₐV_{b}O_{c}M_{d} may have a disordered rocksalt structure in the Fm3̅m space group.

The LiₐV_{b}O_{c}M_{d} (doped anode material) may have a density of about 1.5 g/cm³ to about 5.5 g/cm³. Preferably, at least 50 wt % or at least 90 wt % of the LiₐV_{b}O_{c}M_{d} has a disordered rocksalt structure in the Fm3̅m space group. In various embodiments, at least 50 wt %, 60 wt %, 70 wt %, 80 wt %, 90 wt %, 95 wt %, or 99 wt % (such as 100 wt %) of the LiₐV_{b}O_{c}M_{d} has a disordered rocksalt structure in the Fm3̅m space group.

In some embodiments, the anode-material particles have a shape selected from the group consisting of spherical, columnar, cubic, irregular, and combinations thereof. The anode-material particles may have an average effective diameter selected from about 0.01 microns to about 100 microns, for example. In various embodiments, the average effective diameter of the anode-material particles is about, at least about, or at most about 0.01, 0.05, 0.1, 0.2, 0.3, 0.4, 0.5, 1, 1.5, 2, 2.5, 3, 4, 5, 10, 15, 20, 25, 30, 40, 50, 60, 70, 80, 90, or 100 microns, including any intervening ranges. The anode-material particles may have a unimodal or a multimodal size distribution.

Particle sizes may be measured by a variety of techniques, including dynamic light scattering, laser diffraction, or image analysis, for example. Dynamic light scattering is a non-invasive, well-established technique for measuring the size and size distribution of particles typically in the submicron region, and with the latest technology down to 1 nanometer. Laser diffraction is a widely used particle-sizing technique for materials ranging from hundreds of nanometers up to several millimeters in size. Exemplary dynamic light scattering instruments and laser diffraction instruments for measuring particle sizes are available from Malvern Instruments Ltd., Worcestershire, UK. Image analysis to estimate particle sizes and distributions can be done directly on photomicrographs, scanning electron micrographs, or other images.

The anode layer may further contain, in addition to the lithium vanadium oxide, a second anode material selected from the group consisting of silicon, silicon oxide, carbon (in one or more of various forms, typically graphite, hard carbon, and/or soft carbon), a silicon-carbon composite, aluminum, magnesium, zinc, tin, tin oxide, and combinations thereof. The second anode material may be physically mixed (e.g., blended) with the lithium vanadium oxide, coated onto the lithium vanadium oxide, or a combination thereof, for example.

The anode layer preferably contains an anode carbon additive in sp form, sp² form, and/or sp³ form. The anode carbon additive may be graphite, graphene, carbon nanotubes, carbon fibers (e.g., vapor-grown carbon fiber), non-graphitized carbon, ultrafine carbon, activated carbon, carbon black, nanodiamonds, hard carbon, soft carbon, or a combination thereof.

In some embodiments, the anode material is characterized in that it is chemically stable in the presence of air. In this disclosure, chemical stability in the presence of air is determined at atmospheric pressure (1 bar) and room temperature (25° C.) for at least 1 day, preferably at least 1 week, and more preferably at least 1 month.

In some, the anode material is characterized in that it is chemically stable in the presence of water. In this disclosure, chemical stability in the presence of water is determined at atmospheric pressure (1 bar) and room temperature (25° C.), in a water soak, for at least 1 hour, preferably at least 2 hours, and more preferably at least 3 hours.

In some embodiments, the anode further contains one or more binders. Binders may hold active anode material together as well as place the active anode material in contact with the anode substrate (e.g., copper foil). The binders may also help keep conductive carbon additives in place against the active material.

The binders may be aqueous-based binders selected from the group consisting of carboxymethyl cellulose, styrene-butadiene rubber, styrene-butadiene copolymer, polyacrylic acid, lithium-substituted polyacrylic acid, and combinations thereof, for example. Alternatively, or additionally, the binders may be non-aqueous-based binders selected from the group consisting of polyvinylidene fluoride, poly(vinylidenefluoride-co-hexafluoropropylene), polytetrafluoroethylene, and combinations thereof, for example.

The binders may range in concentration from about 0 wt % to about 50 wt % of the anode, for example. In various embodiments, the binders collectively have a total concentration of about, at least about, or at most about 0 wt %, 0.25 wt %, 0.5 wt %, 1 wt %, 2 wt %, 5 wt %, 10 wt %, 15 wt %, 20 wt %, 25 wt %, 30 wt %, 40 wt %, 50 wt %, 60 wt %, 70 wt %, or 80 wt %, including any intervening ranges.

In some embodiments, the anode has a volumetric anode porosity selected from about 5% to about 80%. In various embodiments, the anode has a volumetric anode porosity of about, at least about, or at most about 5%, 10%, 15%, 20%, 25%, 30%, 40%, 50%, 60%, 70%, or 80%, including any intervening ranges.

In some embodiments, the anode has an average anode thickness from about 100 nanometers to about 500 microns. In various embodiments, the anode has an average anode thickness of about, at least about, or at most about 100 nm, 200 nm, 300 nm, 400 nm, 500 nm, 1 μm, 2 μm, 5 μm, 10 μm, 15 μm, 20 μm, 25 μm, 30 μm, 40 μm, 50 μm, 60 μm, 70 μm, 80 μm, 90 μm, 100 μm, 200 μm, 300 μm, 400 μm, or 500 μm, including any intervening ranges.

The anode layer may contain silicon as well as the lithium vanadium oxide LiₐV_{b}O_{c}. For example, the anode layer may have a composition as disclosed in WO 2022/178246 A1, published on Aug. 25, 2022, which is incorporated by reference. Some variations utilize an anode material comprising: (a) a porous anode phase comprising silicon, wherein the porous phase is characterized by a porous-phase volumetric porosity that is selected from about 5% to about 80%; and (b) a first solid-state mediator layer outwardly disposed on the porous anode phase, wherein the first solid-state mediator layer contains a lithium vanadium oxide material, wherein the lithium vanadium oxide material has a density of about 2.0 g/cm³ to about 5.5 g/cm³, wherein the lithium vanadium oxide material has a composition given by LiₐV_{b}O_{c}, wherein a=0-10, b=1-3, c=1-9, and a, b, and c are selected to charge-balance the LiₐV_{b}O_{c}, and wherein the LiₐV_{b}O_{c} is capable of being reversibly lithiated. In some embodiments, the anode material is a core-shell material in which the first solid-state mediator layer forms a shell that encapsulates the porous anode phase. In some embodiments, the anode material is a sandwiched material in which the first solid-state mediator layer is outwardly disposed on a first side of the porous anode phase, wherein a second solid-state mediator layer is outwardly disposed on a second side of the porous anode phase, and wherein the second solid-state mediator layer contains the lithium vanadium oxide material. The silicon may be present in the porous anode phase in a concentration from about 1 wt % to 100 wt % Si. The silicon may be amorphous silicon, polycrystalline silicon, or single-crystalline silicon. The silicon may have an average particle size from about 10 nanometers to about 100 microns, for example. The silicon may be present as particles with a particle geometry selected from the group consisting of spheres, columns, cubes, cylinders, tubes, wires, sheets, fibers, irregular shapes, and combinations thereof, for example.

In some embodiments of the solid-state lithium-ion battery, the anode layer further contains a second anode material selected from the group consisting of silicon, silicon oxide, graphite, hard carbon, soft carbon, a silicon-carbon composite, aluminum, magnesium, zinc, tin, tin oxide, and combinations thereof.

The anode may be present in a cell. A “cell” is an electrochemical cell that is capable of either generating electrical energy from chemical reactions or using electrical energy to cause chemical reactions.

The cell may further comprise a cathode, an electrolyte layer, and a packet foil surrounding the anode, the electrolyte layer, and the cathode, wherein the electrolyte layer electrically separates the anode from the cathode. The anode composite may be disposed on a first substrate (e.g., copper foil) to form an anode, and the cathode composite may be disposed on a second substrate (e.g., aluminum foil) to form a cathode. There may be multiple layers of anode, electrolyte layer, and cathode, in a layered cell configuration. The layers are repeatedly stacked to form multi-layer stackings in a cell configuration, forming anode, electrolyte layer, cathode, electrolyte layer, anode, electrolyte layer, cathode, electrolyte layer . . . and so on, depending on total number of layers.

The packet foil insulates the anode-electrolyte layer-cathode assembly from the external environment. The packet foil may be fabricated from polymers, such as polyamide, polyester-polyurethane, polypropylene, and/or metals, such as aluminum. The thickness of the packet foil may range from about 20 μm to about 200 μm.

In some embodiments, the anode has an anode material loading selected from about 20 wt % to about 100 wt %, such as about 20 wt %, 30 wt %, 40 wt %, 50 wt %, 60 wt %, 70 wt %, 80 wt %, 90 wt %, or 100 wt %, including any intervening ranges.

In some embodiments, the anode has an anode material areal loading selected from about 0.2 mg/cm² to about 50 mg/cm² on at least one side of the anode, such as about 0.2, 0.5, 1, 2, 5, 10, 15, 20, 25, 30, 35, 40, 45, or 50 mg/cm², including any intervening ranges, on at least one side of the anode (e.g., on both sides of the anode).

In some embodiments, the anode has an anode material areal capacity selected from about 0.05 mA·h/cm² to about 10 mA·h/cm² on at least one side of the anode, such as about 0.05, 0.1, 0.2, 0.5, 1, 2, 3, 4, 5, 6, 7, 8, 9, or 10 mA·h/cm², including any intervening ranges, on at least one side of the anode (e.g., on both sides of the anode).

In some embodiments, the anode has a capacity ranging from about 50 mA·h/g to about 2500 mA·h/g, such as about 50, 100, 150, 200, 250, 300, 350, 400, 450, 500, 600, 700, 800, 900, 1000, 1100, 1200, 1300, 1400, 1500, 1600, 1700, 1800, 1900, 2000, 2100, 2200, 2300, 2400, or 2500 mA·h/g, including any intervening ranges.

In some embodiments, the anode has a negative to positive electrode ratio (N/P ratio) ranging from about 0.5 to about 2, such as about 0.5, 0.6, 0.7, 0.8, 0.9, 1.0, 1.1, 1.2, 1.3, 1.4, 1.5, 1.6, 1.7, 1.8, 1.9, or 2.0, including any intervening ranges.

A copper foil, or other metal foil, may be used as a substrate upon which to place the anode material. In some embodiments, the copper foil thickness may range from about 1 μm to about 100 μm, such as about 1, 5, 10, 20, 30, 40, or 50 μm, including any intervening ranges. In some embodiments, the anode press density may range from about 0.3 g/cm³ to about 5 g/cm³, such as about 0.3, 0.4, 0.5, 1, 1.5, 2, 2.5, 3, 3.5, 4, 4.5, or 5 g/cm³, including any intervening ranges.

When the anode material is disposed on a substrate, typically the anode material is disposed on both sides of a substrate layer. This is referred to as a double layer. Within a cell, the number of double layers may vary widely, such as from 1 to about 50, e.g. about 1, 2, 3, 4, 5, 10, 15, 20, 25, 30, 35, 40, 45, 50, or more.

The anode material may be able to facilitate Li-ion battery charging on the scale of minutes without a complicated nanosizing process. The anode material may enable a fast charge battery without sacrificing energy density. In some embodiments, the anode material may show a voltage plateau ranging from about 0 V to about 2 V. The range of the voltage potential may ensure that under high current, the anode potential achieves a value that does not cause lithium plating. The range of the voltage potential may also ensure that the average cell voltage does not decrease to less than about 1.5 V, when a common cathode material is used.

The cathode material may be selected from the group consisting of LiCoO₂, LiMn₂O₄, Li₂MnO₃, LiFePO₄, LiNiₓCo_{y}Al_{z}O₂ (x+y+z=1), LiMnₓNi_{y}O₄ (x+y=2), LiNiₓCo_{y}Mn_{z}O₂ (x+y+z=1), LiFeₓMn_{y}PO₄ (x+y=1), aLiNiₓCo_{y}Mn_{z}O₂·(1−a)Li₂MnO₃ (0<a<1 and x+y+z=1), and combinations thereof, for example. In some embodiments, the cathode material is the LiNiₓCo_{y}Mn_{z}O₂. The LiNiₓCo_{y}Mn_{z}O₂ may be LiNi_{0.8}Co_{0.1}Mn_{0.1}O₂, for example. Other cathode materials may be utilized. The cathode may be paired with an anode based on each electrode's composition.

The cathode layer preferably further contains a cathode carbon additive in sp form, sp² form, and/or sp³ form. The cathode carbon additive may be graphite, graphene, carbon nanotubes, carbon fibers (e.g., vapor-grown carbon fiber), non-graphitized carbon, ultrafine carbon, activated carbon, carbon black, nanodiamonds, hard carbon, soft carbon, or a combination thereof. The cathode carbon additive may be the same type of carbon as the anode carbon additive, or they may be different types of carbon.

In some embodiments, the cathode may have a capacity ranging from about 50 mA·h/g to about 400 mA·h/g, for example. In some embodiments, the active cathode material loading may range from about 50 wt % to about 100 wt %. In some embodiments, the coating weight for each side of the cathode may range from about 0.5 mg/cm² to about 50 mg/cm². In some embodiments, the areal capacity for each side of the cathode may range from about 0.2 mA·h/cm² to about 10 mA·h/cm².

In some embodiments, the cathode press density may range from about 0.3 g/cm³ to about 5 g/cm³. Aluminum foil may be used as a substrate upon which to place the cathode material. In some embodiments, the aluminum foil thickness may range from about 1 μm to about 100 μm. The number of cathode double layers may range from 1 to about 50, for example.

The solid electrolyte promotes the movement of ions between the cathode and the anode during charge and discharge. During charging, the lithium ions transport from cathode to anode; while discharging the lithium ions transport from anode to cathode.

In various embodiments, the solid electrolyte is selected from the group consisting of oxides, sulfides, phosphates, argyrodites, β-aluminas, LISICON, garnets, NASICON, perovskites, antiperovskites, lithium nitrides (e.g., lithium metal nitrides), lithium hydrides (e.g., lithium metal hydrides), lithium phosphidotrielates, lithium phosphidotetrelates, lithium halides (e.g., lithium chloride), lithium metal halides (e.g., lithium metal chlorides), UPON, lithium thiophosphates, and combinations thereof. Lithium metal chlorides, Li-M-Cl, may utilize a non-lithium metal M such as, but not limited to, Y, Tb, Lu, Sc, Er, In, or Zr. An exemplary lithium metal chloride is Li₂ZrCl₆. Another exemplary lithium metal chloride is Li₃YCl₃. Generally, in some embodiments, the solid electrolyte may be selected from lithium metal halides Li-M-X, where M=Y, Tb, Lu, Sc, Er, In, or Zr; and X=Cl, Br, I. In this specification, “lithium metal halide” refers to a material that has a metal other than lithium, in addition to lithium.

In some embodiments, solid electrolyte materials can be based on oxides, sulfides, or phosphates, and can have a variety of crystalline structures. Some examples of these structures include LISICON (lithium superionic conductor) (e.g., Li₂₊₂ₓZn₁₋ₓGeO₄, Li₁₄Zn(GeO₄)₄, Li₍₃₊ₓ₎GeₓV₍₁₋ₓ₎O₄, Li_{3.6}Ge_{0.6}V_{0.4}O₄, Li_{3.6}Ge_{0.6}V_{0.4}O₄, Li₍₄₋ₓ₎Si₍₁₋ₓ₎PₓO₄, Li_{3.5}Si_{0.5}P_{0.5}O₄, and/or Li_{3.4}Si_{0.4}P_{0.6}O₄); argyrodite-like structures (e.g. Li₆PS₅X, X=Cl, Br, I); garnets (e.g., LLZO, Li₇La₃Zr₂O₁₂); NASICON (sodium superionic conductor); lithium nitrides (e.g., Li₃N); lithium hydrides (e.g., LiBH₄); lithium phosphidotrielates or phosphidotetrelates; perovskites (e.g., lithium lanthanum titanate, LLTO); and lithium metal halides (e.g., Li₃YCl₆ or Li₃YBr₆). Additionally, some inorganic solid electrolytes can be in an amorphous state, resembling glass ceramics. Examples of these include lithium phosphorus oxynitride (LIPON) and lithium thiophosphates (Li₂S—P₂S₅).

In some embodiments, the solid electrolyte is a sulfur-based superionic conductor, such as a halogen-containing lithium argyrodite. The halogen-containing lithium argyrodite may be selected from Li_{6-ε}PS_{5-ε}X_{1+ε}, wherein −1<ε≤1, and wherein X=F, Cl, Br, I, or a combination thereof. For example, X may be Cl, and 0≤ε≤0.8. In some embodiments, the sulfur-based superionic conductor is selected from the group consisting of Li₂S—P₂S₅, Li₇P₃S₁₁, Li₁₀GeP₂S₁₂, Li₇SiPS₈, Li₃PS₄, Li₁₊₂ₓZn₁₋ₓPS₄ (0≤x<1), and combinations thereof.

In some embodiments, the solid electrolyte is an oxide-based superionic conductor. The oxide-based superionic conductor may be selected from the group consisting of Li—Al₂O₃, Li₇La₃Zr₂O₁₂, Li₂₊₂ₓZn₁₋ₓGeO₄ (0≤x≤1), Li₁₊ₓZr₂SiₓP₃ₓO₁₂ (0<x<3), La_{2/3-x}Li₃ₓTiO₃ (0<x<⅔), LiₓX¹₃X²₂O₁₂ (X¹=La, Nd, Mg, or Ba; X²=Te, Ta, Nb, Zr, or In; and 0<x<7), and combinations thereof.

In some embodiments, the solid electrolyte is a phosphate-based superionic conductor. The phosphate-based superionic conductor may be selected from the group consisting of Li₃PO₄, Li₁₊₁X¹ₓX²₁₊ₓ(PO₄)₃ (X¹=Al, La, In, or Cr; X²=Ti, Ge, Zr, Hf, or Sn; and 0<x<2), and combinations thereof.

In some embodiments, the solid electrolyte is a nitride-based superionic conductor. The nitride-based superionic conductor may be selected from the group consisting of Li₃N, LiₓPO_{y}N_{z} (0<x≤3; 0<y≤4; and 0<z≤1), and combinations thereof.

In some embodiments, the solid electrolyte is a hydride-based superionic conductor. The hydride-based superionic conductor may be selected from the group consisting of LiBH₄, LiCB₉H₁₀, LiCB₁₁H₁₂, and combinations thereof.

In some embodiments, in which the solid electrolyte is selected from antiperovskites, the antiperovskites are selected from the group consisting of Li₃OCl, Li₃OBr, Li₃OF, Li₃OI, and combinations thereof.

In some embodiments, the solid electrolyte layer contains a mixed electrolyte, i.e., a mixture of two or more different types of solid electrolyte. In some embodiments, the solid electrolyte layer contains or consists of a few different layers with different solid electrolyte materials.

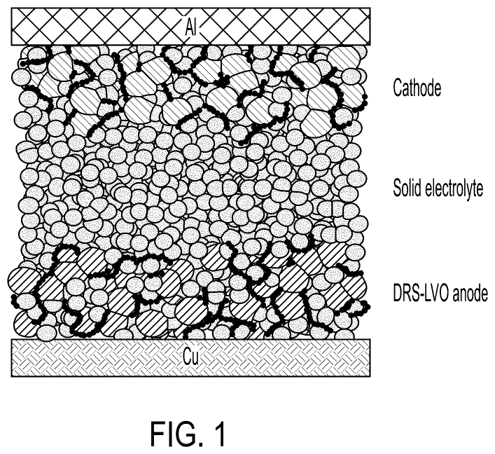

In some solid-state lithium-ion batteries, the solid electrolyte is also contained within the anode layer, such as depicted in FIG. 1. In these or other embodiments, the solid electrolyte is also contained within the cathode layer, also as depicted in FIG. 1. The anode layer and the cathode layer may incorporate different solid electrolytes.

In certain embodiments, the anode layer, the cathode layer, or the solid electrolyte layer further contains a noble metal in neutral or ionic form. The noble metal is typically present only in trace concentrations. The noble metal may be selected from the group consisting of Au, Ag, Pt, Rh, Pd, Ru, Os, Ir, and combinations thereof.

Typically, the cathode layer is disposed on a cathode current collector (e.g., Al foil), and the anode layer is disposed on an anode current collector (e.g., Cu foil).

In some embodiments, the solid-state lithium-ion battery contains a plurality of anode layers, a plurality of solid electrolyte layers, and a plurality of cathode layers.

FIG. 1 is a schematic illustration of an exemplary solid-state lithium-ion battery. In FIG. 1, a solid electrolyte is stacked between a DRS-LVO anode and a cathode. The anode contains DRS-LVO anode material (depicted as gray spheres), conductive carbon (depicted as black curves), and solid electrolyte (depicted as yellow spheres). The cathode contains cathode material (depicted as light-red spheres), conductive carbon (depicted as black curves), and solid electrolyte (depicted as yellow spheres). There is a layer of solid electrolyte (depicted as yellow spheres) that does not contain cathode or anode materials or conductive carbon. Other materials, such as binders, may be present (not shown). In FIG. 1, a single-layer unit cell is stacked by one copper (Cu) current collector, one anode layer, one solid-electrolyte layer, one cathode layer, and an aluminum (Al) current collector. Typical cells are multilayer cells which repeat the stacking of the single-layer unit cell into many stacked layers.

In some embodiments, the solid-state lithium-ion battery is capable of maintaining at least 80% battery capacity after performing 5,000, 10,000, 15,000, or 20,000 cycles. In various embodiments, the solid-state lithium-ion battery is capable of maintaining at least 80%, at least 85%, at least 90%, or at least 95% battery capacity after performing 10,000 cycles.

In some embodiments, the solid-state lithium-ion battery is capable of charging to 80%, 90%, or 100% state of charge in 3 minutes or less. In various embodiments, the solid-state lithium-ion battery is capable of charging to 80% state of charge in 2 minutes or less, or in 1 minute or less. In various embodiments, the solid-state lithium-ion battery is capable of charging to 90% state of charge in 2 minutes or less, or in 1 minute or less. In various embodiments, the solid-state lithium-ion battery is capable of charging to 95% state of charge in 3 minutes or less, or in 2 minutes or less, or in 1 minute or less. In various embodiments, the solid-state lithium-ion battery is capable of charging to 99% state of charge in 3 minutes or less, or in 2 minutes or less, or in 1 minute or less. In certain embodiments, the solid-state lithium-ion battery is capable of charging to 100% state of charge in 3 minutes or less, or in 2 minutes or less, or in 1 minute or less.

In some embodiments, the solid-state lithium-ion battery has an energy density of at least 200 W·h/kg. In certain embodiments, the solid-state lithium-ion battery has an energy density of at least 650 W·h/L. In various embodiments, the solid-state lithium-ion battery has an energy density of about, or at least about, 100, 150, 200, 250, 300, 350, 400, 450, 500, 550, 600, 650, 700, or 750 W·h/L, including any intervening range.

In some embodiments, the solid-state lithium-ion battery is capable of operating in a temperature range from about −80° C. to about 350° C.

In some embodiments, the solid-state lithium-ion battery does not undergo lithium metal plating during operation.

In some embodiments, the solid-state lithium-ion battery is contained within a battery module or battery pack comprising a plurality of batteries. A battery pack may contain a plurality of battery modules. The battery module or pack may be contained within an electric vehicle, for example, or a variety of other battery applications.

In some embodiments, the solid-state lithium-ion battery is used in an electric vehicle. The electric vehicle may be an electric automobile, an electric truck, an electric bus, an electric locomotive, or an electric airplane, for example. Large car companies are exploring solid-state batteries to extend driving range and reduce charging times. Buses and trucks that require longer ranges and durability are also potential beneficiaries of the disclosed solid-state lithium-ion battery. Heavy machinery utilizing the solid-state lithium-ion battery allows for more efficient and safer operation in mining and construction.

In some embodiments, the solid-state lithium-ion battery is used in a maritime application. For example, electric or hybrid marine vessels using the solid-state lithium-ion battery may reduce emissions and fuel consumption in marine transportation.

In some embodiments, the solid-state lithium-ion battery is contained within a portable device, such as a portable computer or a smart device. In the area of smartphones, for example, tech companies are investigating solid-state batteries to enhance safety and battery life. In the area of wearable technologies (e.g., smartwatches and fitness trackers), more compact and longer-lasting batteries for these devices are desired. In the area of smart home devices, a home energy storage system may be integrated with home solar systems to provide reliable power during outages or off-peak hours.

In some embodiments, the solid-state lithium-ion battery is contained within an emergency power backup system. The emergency power backup system may be used in essentially any application that needs reliable electricity, including homes, offices, warehouses, laboratories, hospitals, industrial plants (including, but not limited to, electrolysis facilities), data centers, satellites, electric vehicles, etc. Emergency power backup systems are also important for telecommunications infrastructure.

In some embodiments, the solid-state lithium-ion battery is used in a portable power station. Portable power stations are useful in remote locations that cannot readily access existing power infrastructure. Portable power stations are also useful for emergency power supplies, such as in the event of a natural disaster or a war zone.

In some embodiments, the solid-state lithium-ion battery is contained within an energy storage system. A grid storage system may employ a battery module/pack comprising a plurality of the disclosed solid-state lithium-ion batteries, to better harness and store solar and wind energy, thereby smoothing out the variability of renewable energy sources.

In some embodiments, the solid-state lithium-ion battery is contained within a solar-power electricity storage system, a wind-power electricity storage system, or a hydropower electricity storage system, for example. These embodiments are useful because the renewable power supplies often do not match with the demand for electricity, and when too much power is being generated, sometimes there is no place for the electricity to go. A system of solid-state lithium-ion batteries can be configured to receive excess electricity and store it for use at a later time when demand exceeds dynamic supply, returning electricity to the local grid.

In some embodiments, the solid-state lithium-ion battery is used in an aerospace application. For drones, solid-state batteries can help drones fly longer and carry more payload. For satellites, enhanced energy density can extend the operational life of satellites and other spacecraft.

In some embodiments, the solid-state lithium-ion battery is used in a military or defense application. In the area of portable electronics for soldiers, there is great interest in enhancing the reliability of devices used in field operations. For military vehicles, the solid-state lithium-ion battery may provide more reliable and safer energy solutions for vehicles in extreme environments.

In some embodiments, the solid-state lithium-ion battery is used in a medical device. For example, implantable medical devices, such as pacemakers and neurostimulators, benefit from the solid-state lithium-ion battery's enhanced safety and longevity. In the area of wearable robotics, such as exoskeletons for medical rehabilitation, the solid-state lithium-ion battery may improve battery life and reduce weight to assist mobility.

Exemplary methods of making and using lithium vanadium oxide will now be further described.

Some variations of the invention provide a method of manufacturing a cell, the method comprising:
(a) casting an anode material, an anode carbon additive, and a solid electrolyte onto a first substrate to form an anode, wherein the anode material comprises a plurality of anode-material particles, wherein the anode-material particles comprise an internal phase containing LiₓV_{y}O_{z}, wherein x=0-10, y=1-3, z=1-9, and x, y, and z are selected to charge-balance the LiₓV_{y}O_{z};
(b) pressing a Li foil onto the anode, to form a pressed anode;
(c) casting a cathode material, a cathode carbon additive, and the solid electrolyte onto a second substrate, to form a cathode;
(d) stacking a solid electrolyte layer onto the pressed anode, wherein the solid electrolyte layer comprises the solid electrolyte;
(e) stacking the cathode onto the solid electrolyte layer;
(f) surrounding multiple layers of the anode, multiple layers of the solid electrolyte layer, and multiple layers of the cathode with a packet foil, to form a cell; and
(g) converting the pressed anode into a lithiated anode comprising LiₐV_{b}O_{c}, wherein a=0.001-10, b=1-3, c=1-9, and a, b, and c are selected to charge-balance the LiₐV_{b}O_{c}, wherein the LiₐV_{b}O_{c} is capable of being reversibly lithiated, and wherein at least some of the LiₐV_{b}O_{c} has a disordered rocksalt structure in the Fm3̅m space group.

In some methods, the anode-material particles further contain a dopant M that is chemically or physically contained within the anode-material particles with composition given by LiₐV_{b}O_{c}M_{d}, wherein d=0.001-3, wherein a, b, c, and d are selected to charge-balance the LiₐV_{b}O_{c}M_{d}, wherein the LiₐV_{b}O_{c}M_{d} is capable of being reversibly lithiated, and wherein at least some of the LiₐV_{b}O_{c}M_{d} has a disordered rocksalt structure in the Fm3̅m space group.

The raw material for the disordered rocksalt LiₐV_{b}O_{c} or LiₐV_{b}O_{c}M_{d} may be a vanadium oxide, such as V₂O₅ (vanadium pentoxide), of varying initial purity such as a low-grade material, <98 wt % V₂O₅; a medium-grade material, 98-99 wt % V₂O₅; or a high-grade material, >99 wt % V₂O₅. The V₂O₅ may be monocrystalline, polycrystalline, or amorphous. The V₂O₅ may be in the form of a hydrate. The particle size of the V₂O₅ (or other vanadium oxide, such as VO, VO₂, or V₂O₃) may be from about 0.2 microns to about 100 microns, for example, and may have a narrow, medium, or large size distribution or a multimodal size distribution. The particles of vanadium oxide may be spherical, columnar, cubic, flake, irregular, or a mixture of different shapes.

When a dopant is utilized, the dopant may be incorporated following lithiation, i.e., the dopant is added to LiₐV_{b}O_{c} to form LiₐV_{b}O_{c}M_{d}. Alternatively, or additionally, the dopant may be incorporated into V₂O₅ prior to lithiation, to form doped vanadium oxide, V_{b}O_{c}M_{d}, wherein b=1-3, c=1-9, and d=0.001-3. The doped vanadium oxide may have be a low-grade material, <98 wt % V_{b}O_{c}M_{d}; a medium-grade material, 98-99 wt % V_{b}O_{c}M_{d}; or a high-grade material, >99 wt % V_{b}O_{c}M_{d}. The V_{b}O_{c}M_{d} may be monocrystalline, polycrystalline, or amorphous. The particle size of the V_{b}O_{c}M_{d} may be from about 0.2 microns to about 100 microns, for example, and may have a narrow, medium, or large size distribution or a multimodal size distribution. The particles of doped vanadium oxide V_{b}O_{c}M_{d} may be spherical, columnar, cubic, flake, irregular, or a mixture of different shapes.

In some methods, the anode material, the anode carbon additive, and the solid electrolyte are coated on both sides of a layer of the first substrate; and the cathode material, the cathode carbon additive, and the solid electrolyte are coated on both sides of a layer of the second substrate.

In some methods, step (a) utilizes a casting pressure selected from about 10 kPa to about 250 MPa. In various embodiments, the casting pressure is about, at least about, or at most about 0.1, 1, 10, or 100 MPa, including any intervening range.

In some methods, step (b) utilizes a pressing pressure selected from about 1 MPa to about 100 MPa. In various embodiments, the pressing pressure is about, at least about, or at most about 1, 10, or 100 MPa, including any intervening range.

In some methods, the first substrate is a copper foil with a thickness from about 1 micron to about 100 microns. In some methods, the second substrate is an aluminum foil with a thickness from about 1 micron to about 100 microns.

In some methods, the anode has an anode material loading selected from about 20 wt % to about 100 wt %. In some methods, the anode has an anode material areal loading selected from about 0.2 mg/cm² to about 50 mg/cm² on at least one side of the anode. In some methods, the anode has an anode material areal capacity selected from about 0.05 mA·h/cm² to about 10 mA·h/cm² on at least one side of the anode.

Other variations provide a method of manufacturing a cell, the method comprising:
(a) casting an anode material, an anode carbon additive, and a solid electrolyte onto a first substrate to form an anode, wherein the anode material comprises a plurality of anode-material particles, wherein the anode-material particles comprise an internal phase containing LiₐV_{b}O_{c}, wherein a=0.001-10, b=1-3, c=1-9, and a, b, and c are selected to charge-balance the LiₐV_{b}O_{c};
(b) casting a cathode material, a cathode carbon additive, and the solid electrolyte onto a second substrate, to form a cathode;
(c) stacking a solid electrolyte layer onto the anode, wherein the solid electrolyte layer comprises the solid electrolyte;
(d) stacking the cathode onto the solid electrolyte layer; and
(e) surrounding multiple layers of the anode, multiple layers of the solid electrolyte layer, and multiple layers of the cathode with a packet foil, to form a cell, wherein the LiₐV_{b}O_{c} is capable of being reversibly lithiated, and wherein at least some of the LiₐV_{b}O_{c} has a disordered rocksalt structure in the Fm3̅m space group.

The anode-material particles may further contain a dopant M that is chemically or physically contained within the anode-material particles with composition given by LiₐV_{b}O_{c}M_{d}, wherein d=0.001-3, wherein a, b, c, and d are selected to charge-balance the LiₐV_{b}O_{c}M_{d}, wherein the LiₐV_{b}O_{c}M_{d} is capable of being reversibly lithiated, and wherein at least some of the LiₐV_{b}O_{c}M_{d} has a disordered rocksalt structure in the Fm3̅m space group.

The anode material, the anode carbon additive, and the solid electrolyte may be coated on both sides of a layer of the first substrate. Similarly, the cathode material, the cathode carbon additive, and the solid electrolyte may be coated on both sides of a layer of the second substrate.

Step (a) may utilize a casting pressure selected from about 10 kPa to about 250 MPa, for example. In various embodiments, the casting pressure is about, at least about, or at most about 0.1, 1, 10, or 100 MPa, including any intervening range.

The first substrate may be a copper foil with a thickness from about 1 micron to about 100 microns. The second substrate may be an aluminum foil with a thickness from about 1 micron to about 100 microns.

The fabricated anode (i.e., the anode resulting from step (a)) may have an anode material loading selected from about 20 wt % to about 100 wt %. The fabricated anode may have an anode material areal loading selected from about 0.2 mg/cm² to about 50 mg/cm² on at least one side of the anode. The fabricated anode may have an anode material areal capacity selected from about 0.05 mA·h/cm² to about 10 mA·h/cm² on at least one side of the anode.

Still other variations provide a method of manufacturing a cell, the method comprising:
(a) casting an anode material, an anode carbon additive, a solid electrolyte, and a Li metal onto a first substrate to form an anode, wherein the anode material comprises a plurality of anode-material particles, wherein the anode-material particles comprise an internal phase containing LiₓV_{y}O_{z}, wherein x=0-10, y=1-3, z=1-9, and x, y, and z are selected to charge-balance the LiₓV_{y}O_{z};
(b) casting a cathode material, a cathode carbon additive, and the solid electrolyte onto a second substrate, to form a cathode;
(c) stacking a solid electrolyte layer onto the anode, wherein the solid electrolyte layer comprises the solid electrolyte;
(d) stacking the cathode onto the solid electrolyte layer;
(e) surrounding multiple layers of the anode, multiple layers of the solid electrolyte layer, and multiple layers of the cathode with a packet foil, to form a cell; and
(f) converting the anode into a lithiated anode comprising LiₐV_{b}O_{c}, wherein a=0.001-10, b=1-3, c=1-9, and a, b, and c are selected to charge-balance the LiₐV_{b}O_{c}, wherein the LiₐV_{b}O_{c} is capable of being reversibly lithiated, and wherein at least some of the LiₐV_{b}O_{c} has a disordered rocksalt structure in the Fm3̅m space group.

In some methods using Li metal in step (a) the Li metal is selected from the group consisting of a Li metal powder, a Li metal ingot, a Li metal foil, and combinations thereof.

In some methods using Li metal in step (a), the anode-material particles further contain a dopant M that is chemically or physically contained within the anode-material particles with composition given by LiₐV_{b}O_{c}M_{d}, wherein d=0.001-3, wherein a, b, c, and d are selected to charge-balance the LiₐV_{b}O_{c}M_{d}, wherein the LiₐV_{b}O_{c}M_{d} is capable of being reversibly lithiated, and wherein at least some of the LiₐV_{b}O_{c}M_{d} has a disordered rocksalt structure in the Fm3̅m space group.

In some methods using Li metal in step (a), the anode material, the anode carbon additive, and the solid electrolyte are coated on both sides of a layer of the first substrate.

In some methods using Li metal in step (a), the cathode material, the cathode carbon additive, and the solid electrolyte are coated on both sides of a layer of the second substrate.

In some methods using Li metal in step (a), that step utilizes a casting pressure selected from about 10 kPa to about 250 MPa. In various embodiments, the casting pressure is about, at least about, or at most about 0.1, 1, 10, or 100 MPa, including any intervening range.

In some methods using Li metal in step (a), the first substrate is a copper foil with a thickness from about 1 micron to about 100 microns, and/or the second substrate is an aluminum foil with a thickness from about 1 micron to about 100 microns.

In some methods using Li metal in step (a), the anode has an anode material loading selected from about 20 wt % to about 100 wt %. The anode may have an anode material areal loading selected from about 0.2 mg/cm² to about 50 mg/cm² on at least one side of the anode. The anode may have an anode material areal capacity selected from about 0.05 mA·h/cm² to about 10 mA·h/cm² on at least one side of the anode.

Yet other variations of the invention provide a method of manufacturing a cell, the method comprising:
(a) casting an anode material, an anode carbon additive, and a solid electrolyte onto a first substrate to form an anode, wherein the anode material comprises a plurality of anode-material particles, wherein the anode-material particles comprise an internal phase containing LiₓV_{y}O_{z}, wherein x=0-10, y=1-3, z=1-9, and x, y, and z are selected to charge-balance the LiₓV_{y}O_{z};
(b) casting a cathode material, a cathode carbon additive, the solid electrolyte, and a lithium-containing compound onto a second substrate, to form a cathode, wherein the lithium-containing compound is chemically distinct from the cathode material;
(c) stacking a solid electrolyte layer onto the anode;
(d) stacking the cathode onto the solid electrolyte layer;
(e) surrounding multiple layers of the anode, multiple layers of the solid electrolyte layer, and multiple layers of the cathode with a packet foil, to form a cell; and
(f) decomposing the lithium-containing compound to add lithium to the anode-material particles, thereby converting the anode into a lithiated anode comprising LiₐV_{b}O_{c}, wherein a=0.001-10, b=1-3, c=1-9, and a, b, and c are selected to charge-balance the LiₐV_{b}O_{c}, wherein the LiₐV_{b}O_{c} is capable of being reversibly lithiated, and wherein at least some of the LiₐV_{b}O_{c} has a disordered rocksalt structure in the Fm3̅m space group.

In some methods using decomposition of a lithium-containing compound in step (f), the anode-material particles further contain a dopant M that is chemically or physically contained within the anode-material particles with composition given by LiₐV_{b}O_{c}M_{d}, wherein d=0.001-3, wherein a, b, c, and d are selected to charge-balance the LiₐV_{b}O_{c}M_{d}, wherein the LiₐV_{b}O_{c}M_{d} is capable of being reversibly lithiated, and wherein at least some of the LiₐV_{b}O_{c}M_{d} has a disordered rocksalt structure in the Fm3̅m space group.

In some methods using decomposition of a lithium-containing compound in step (f), the lithium-containing compound is selected from the group consisting of lithium oxide, lithium hydride, lithium hydroxide, lithium hydroperoxide, lithium peroxide, lithium nitride, lithium carbonate, lithium bicarbonate, lithium sulfide, lithium sulfate, lithium squarate, lithium oxalate, lithium ketomalonate, lithium di-ketosuccinate, and combinations thereof. In certain embodiments, the lithium-containing compound is lithium oxide (Li₂O) and/or lithium nitride (Li₃N). For example, when the lithium-containing compound is Li₂O, the decomposition may cause the reaction 2 Li₂O→Li⁺O₂, where the Li atoms enter into the anode material (forming LiₐV_{b}O_{c}) and the oxygen evolves from the system as a gas.

In step (f), the extent of transfer of lithium atoms from the lithium-containing compound to the anode material may be from about 10% to 100%, preferably at least 50%, at least 75%, or at least 90%.

In some methods using decomposition of a lithium-containing compound in step (f), the anode material, the anode carbon additive, and the solid electrolyte are coated on both sides of a layer of the first substrate. Similarly, the cathode material, the cathode carbon additive, and the solid electrolyte may be coated on both sides of a layer of the second substrate.

In some methods using decomposition of a lithium-containing compound in step (f), step (a) utilizes a casting pressure selected from about 10 kPa to about 250 MPa. In various embodiments, the casting pressure is about, at least about, or at most about 0.1, 1, 10, or 100 MPa, including any intervening range.

In some methods using decomposition of a lithium-containing compound in step (f), the first substrate is a copper foil with a thickness from about 1 micron to about 100 microns. In some methods, the second substrate is an aluminum foil with a thickness from about 1 micron to about 100 microns.

In some methods using decomposition of a lithium-containing compound in step (f), the anode has an anode material loading selected from about 20 wt % to about 100 wt %. The anode may have an anode material areal loading selected from about 0.2 mg/cm² to about 50 mg/cm² on at least one side of the anode. The anode may have an anode material areal capacity selected from about 0.05 mA·h/cm² to about 10 mA·h/cm² on at least one side of the anode.

In some methods using decomposition of a lithium-containing compound in step (f), that step is carried out prior to charging of the cell. In other embodiments, step (f) is carried out during charging of the cell, such as when charging the cell for the first time. In certain embodiments, step (f) is carried out both prior to charging of the cell as well as during charging. This can be done, for example, when it is desired to use an elevated temperature for some amount of decomposition of lithium-containing compound (e.g., Li₃N) prior to cell charging.

The battery charge/discharge current may be expressed as a C-rate in order to normalize against battery capacity. A C-rate is a measure of the rate at which a battery is charged/discharged relative to its maximum capacity. A 1C rate means that the charge/discharge current will charge/discharge the battery in 1 hour. For a battery with a capacity of 10 A·h (amp-hours), this equates to a charge/discharge current of 10 A (amps). A 20C rate for this battery would be 200 A, and a C/2 rate would be 5 A.

In typical methods of use, a cell is repeatedly charged and discharged over multiple charge-discharge cycles, wherein the LiₐV_{b}O_{c} is reversibly lithiated and delithiated a plurality of times. The cell may be charged and discharged over at least 1000 cycles, for example. In various embodiments, the number of charge-discharge cycles is 1, 2, 3, 4, 5, 10, 20, 30, 40, 50, 60, 70, 80, 90, 100, 200, 300, 400, 500, 600, 700, 800, 900, 1000, 1100, 1200, 1500, 2000, 2500, 3000, 3500, 4000, 4500, or 5000, or even more, for example.

When the cell undergoes at least one charge-discharge cycle, the lithium vanadium oxide material preferably has a volume change from 0% to about 10% during the charge-discharge cycle(s). In various embodiments, after one charge-discharge cycle, the lithium vanadium oxide material has a volume change of about, or at most about 10%, 9%, 8%, 7%, 6%, 5.5%, 5%, 4.5%, 4%, 3.5%, 3%, 2.5%, 2%, 1.5%, 1%, 0.9%, 0.8%, 0.7%, 0.6%, 0.5%, 0.4%, 0.3%, 0.2%, 0.1%, or 0.0%, including any intervening ranges. In various embodiments, after 2, 3, 4, 5, 10, 20, 30, 40, 50, 60, 70, 80, 90, 100, 200, 300, 400, 500, 600, 700, 800, 900, or 1000 charge-discharge cycles, the lithium vanadium oxide material has a volume change of about, or at most about 10%, 9%, 8%, 7%, 6%, 5.5%, 5%, 4.5%, 4%, 3.5%, 3%, 2.5%, 2%, 1.5%, 1%, 0.9%, 0.8%, 0.7%, 0.6%, 0.5%, 0.4%, 0.3%, 0.2%, 0.1%, or 0.0%, including any intervening ranges.

The battery system may be rechargeable in about, or less than about, 30, 25, 20, 15, 10, 9, 8, 7, 6, 5, 4, 3, 2, 1, 0.5, 0.2, or 0.1 minutes, in various embodiments.

In some embodiments, the presently disclosed technology may be used in a battery system that is superior to conventional graphite battery packs and which has a lower number of cells in the battery pack. This battery system may utilize any one (or more) of the disclosed anode and/or solid-electrolyte materials, and may be coupled with a 4 V high-capacity cathode, such as LiCoO₂, Li-rich oxides, and/or Li(NiMnCo)O₂ layered oxides. The battery system is suitable for many commercial applications, including electric vehicles, smart devices, and high-power portable devices with high energy density.

One skilled in the battery art will appreciate that the principles of battery design, including calculations, modeling, simulations, and engineering may be carried out using the benefit of the present disclosure and the anode materials. One skilled in the battery art, with the benefit of this disclosure, will understand how to scale a battery cell larger or smaller for different battery applications.

In some embodiments of the invention, one or more individual components of a solid-state lithium-ion battery are produced and then sent to another party for incorporating into a cell. In some embodiments of the invention, a cell is produced and then sent to another party for incorporating into a final device or vehicle. In some embodiments of the invention, a cell is produced and then sent to another party for incorporating into a module. In some embodiments of the invention, a module is produced and then sent to another party for incorporating into a final device or vehicle. In some embodiments of the invention, a cell is produced and then sent to another party for incorporating into a pack. In some embodiments of the invention, a module is produced and then sent to another party for incorporating into a pack. In some embodiments of the invention, a pack is produced and then sent to another party for incorporating into a final device or vehicle.

In this detailed description, reference has been made to multiple embodiments and to the accompanying drawings in which are shown by way of illustration specific exemplary embodiments of the technology. These embodiments are described in sufficient detail to enable those skilled in the art to practice the technology, and it is to be understood that modifications to the various disclosed embodiments may be made by a skilled artisan.

Where methods and steps described above indicate certain events occurring in certain order, those of ordinary skill in the art will recognize that the ordering of certain steps may be modified and that such modifications are in accordance with the variations of the technology. Additionally, certain steps may be performed concurrently in a parallel process when possible, as well as performed sequentially.

All publications, patents, and patent applications cited in this specification are herein incorporated by reference in their entirety as if each publication, patent, or patent application were specifically and individually put forth herein. This disclosure hereby incorporates by reference U.S. Patent App. Pub. No. 2021/0184210 A1, published on Jun. 17, 2021. This disclosure also hereby incorporates by reference U.S. Patent App. Pub. No. 20230120748 A1, published on Apr. 20, 2023.

The embodiments, variations, and figures described above should provide an indication of the utility and versatility of the present technology. Other embodiments that do not provide all of the features and advantages set forth herein may also be utilized, without departing from the spirit and scope of the technology. Such modifications and variations are considered to be within the scope of the technology defined by the claims.

While various embodiments of the disclosed technology have been described above, it should be understood that they have been presented by way of example only, and not of limitation. Likewise, the various diagrams may depict an example architectural or other configuration for the disclosed technology, which is done to aid in understanding the features and functionality that can be included in the disclosed technology. The disclosed technology is not restricted to the illustrated example architectures or configurations, but the desired features can be implemented using a variety of alternative architectures and configurations. It will be apparent to one of skill in the art how alternative functional, logical, or physical partitioning and configurations can be implemented to implement the desired features of the technology disclosed herein. Additionally, with regard to flow diagrams, operational descriptions, and methods, the order in which the steps are presented herein shall not mandate that various embodiments be implemented to perform the recited functionality in the same order unless the context dictates otherwise.

Although the disclosed technology is described above in terms of various exemplary embodiments and implementations, it should be understood that the various features, aspects, and functionality described in one or more of the individual embodiments are not limited in their applicability to the particular embodiment with which they are described, but instead can be applied, alone or in various combinations, to one or more of the other embodiments of the disclosed technology, whether or not such features are presented as being a part of a described embodiment. Thus, the breadth and scope of the technology disclosed herein should not be limited by any of the above-described exemplary embodiments. As will become apparent to one of ordinary skill in the art after reading this patent application, the illustrated embodiments and their various alternatives can be implemented without confinement to the illustrated examples.

### EXAMPLES

### Example 1: Ultralong Cycle Life Solid-State Battery Cell Design

To deliver target performance for this example, we modeled the battery cell components shown in Table 1 to determine the target active material loading, electrode thickness, and solid-electrolyte thickness for achieving the desired energy density.

TABLE 1
Ultralong Cycle Life Solid-State Battery
Cell Components and Design Values

| Component | Design Value | |
|---|---|---|
| Al current collector | 8 μm, 2.2 mg/cm² | |
| NMC cathode composite | 45 μm (3 mA · h/cm²), | |
| | 17.6 mg/cm² | |
| Solid electrolyte | 30 μm, 5.7 mg/cm² | |
| LVO anode composite | 57 μm, 16.5 mg/cm² | |
| Cu current collector | 5 μm, 4.5 mg/cm² | |
| Voltage | 3.2 | V |
| N/P ratio | 1.1 | |
| LVO content in anode composite | 80 | wt % |
| NMC content in cathode composite | 85 | wt % |
| LVO capacity | 250 | mA · h/g |
| NMC capacity | 200 | mA · h/g |
| Gravimetric energy density | 206 | W · h/kg |
| Volumetric energy density | 658 | W · h/L |

### Example 2: Lithium-Ion Cell with Li₃PS₄ Solid Electrolyte

A Li∥DRS-LVO cell was assembled using Li₃PS₄ solid electrolyte. The electrode composition is 40% of DRS-LVO, 40% of solid electrolyte, and 20% of vapor-grown carbon fiber.

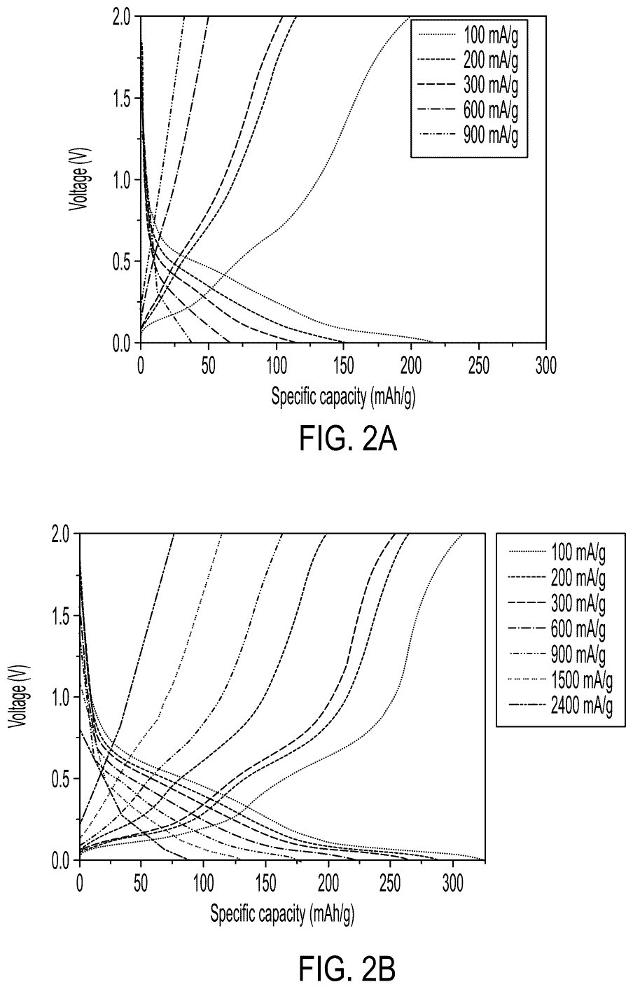

FIGS. 2A and 2B show the performance of the all-solid-state Li∥DRS-LVO cell using the Li₃PS₄ solid electrolyte. FIG. 2A shows voltage profiles of DRS-LVO at room temperature (about 25° C.) under different rates. FIG. 2B shows voltage profiles of DRS-LVO at 60° C. under different rates. The voltage range is 0.01-2 V.

The room-temperature testing results show that the DRS-LVO exhibits a reversible capacity of 200 mA·h/g at 0.5C and only retains 16% (32 mA·h/g) of its capacity at 4.5C (FIG. 2A). The cell test at 60° C. shows that the DRS-LVO exhibits a higher reversible capacity of 305 mA·h/g at 0.5C and retains 53% (162 mA·h/g) and 25% (76 mA·h/g) of its capacity at 4.5C and 12C, respectively, at 60° C. (FIG. 2B).

### Example 3: Lithium-Ion Cell with Li₆PS₅Cl Solid Electrolyte

A Li∥DRS-LVO cell was assembled using Li₆PS₅Cl solid electrolyte. The electrode composition is 40% of DRS-LVO, 40% of solid electrolyte, and 20% of vapor-grown carbon fiber.

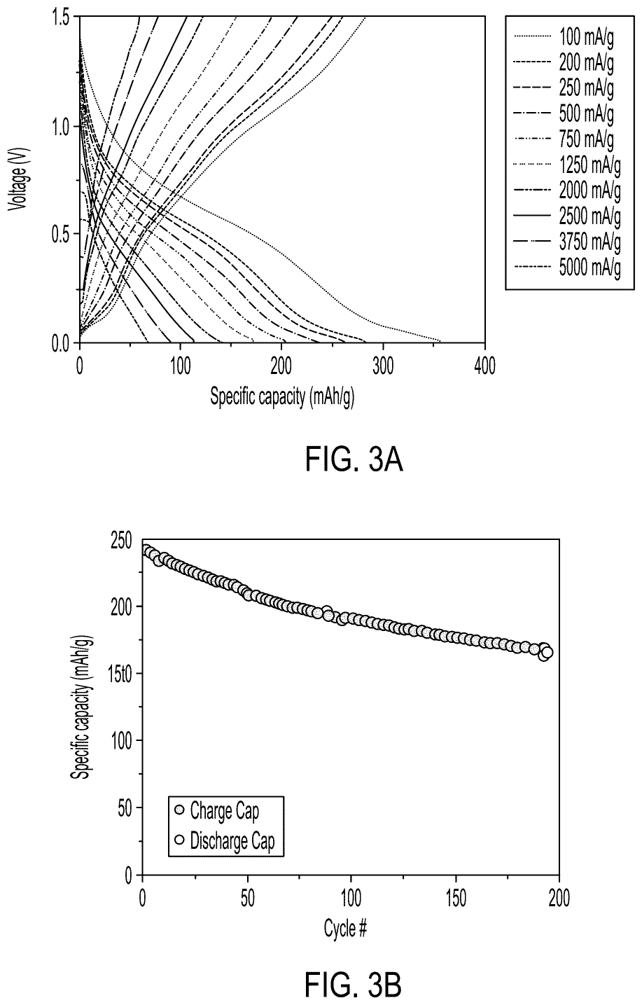

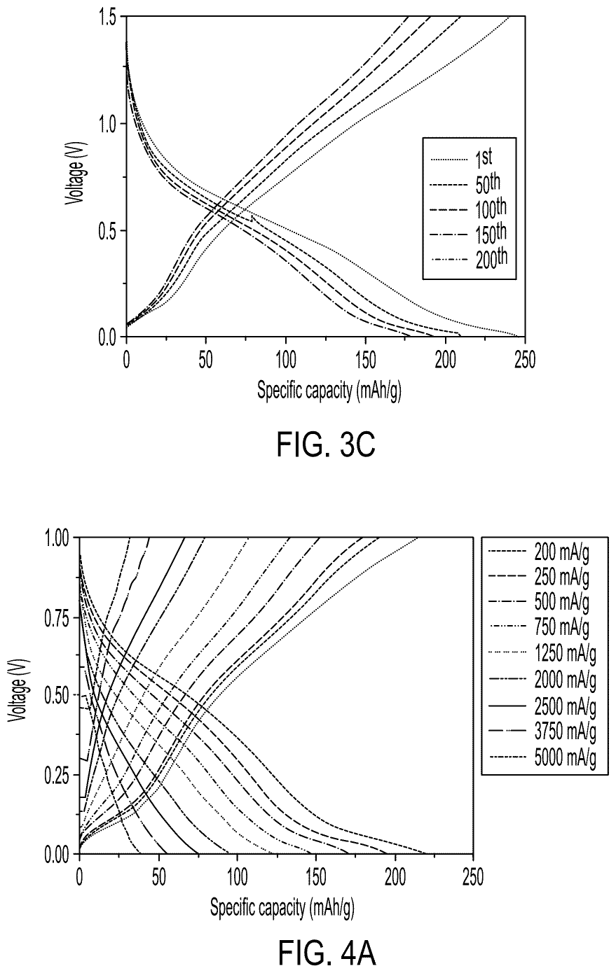

FIGS. 3A, 3B, and 3C show the performance of the all-solid-state Li∥DRS-LVO cell using the Li₆PS₅Cl solid electrolyte. FIG. 3A shows voltage profiles of DRS-LVO at 60° C. under different rates. FIG. 3B shows the cycling performance of the DRS-LVO at 1C. FIG. 3C shows voltage profiles of DRS-LVO at 1C over the course of 200 cycles. The batteries are all tested at 60° C. in this example. The voltage range is 0.01-1.5 V.

The 60° C. testing results show that the DRS-LVO exhibits a reversible capacity of 259 mA·h/g at 1C and retains 44% (113 mA·h/g) and 26% (67 mA·h/g) of its capacity at 12.5C and 25C, respectively, at 60° C. (FIG. 3A). In terms of cycling performance, the results at 60° C. show that the Li∥DRS-LVO cell experiences some degradation, with a capacity of 163 mA·h/g at 1C at the 192th cycle (FIGS. 3B and 3C), suggesting that the operating voltage range of DRS-LVO in an all-solid-state battery can be further optimized. The capacity decrease at the early stage may be associated with degradation at or near electrolyte-anode material interfaces at 60° C., which can be solved by material optimization.

### Example 4: Lithium-Ion Cell with Li₆PS₅Cl Solid Electrolyte

A Li∥DRS-LVO cell was assembled using Li₆PS₅Cl solid electrolyte. The electrode composition is 40% of DRS-LVO, 40% of solid electrolyte, and 20% of vapor-grown carbon fiber. The operating voltage window of the cell is narrowed to 0.01-1 V in this example. The batteries are tested at 60° C.

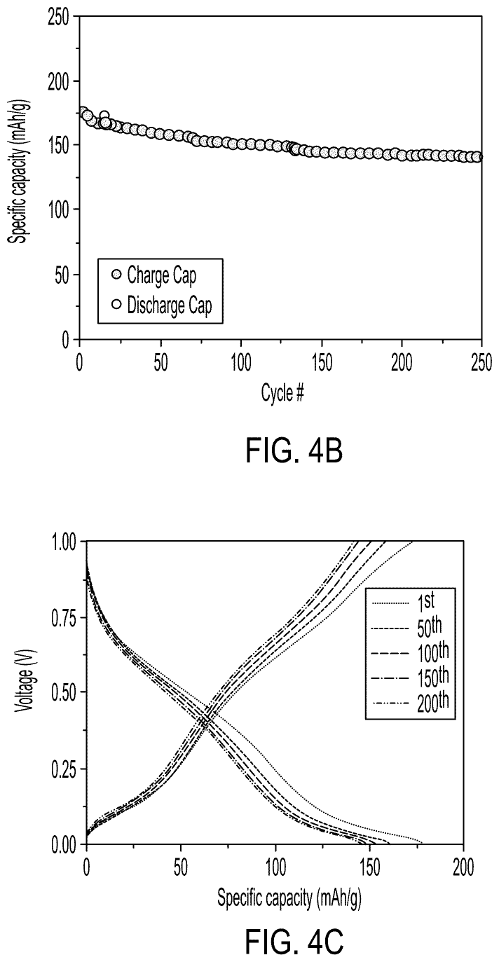

FIGS. 4A, 4B, and 4C depict the performance of an all-solid-state Li∥DRS-LVO cell using the Li₆PS₅Cl solid electrolyte. FIG. 4A shows voltage profiles of DRS-LVO at 60° C. under different rates. FIG. 4B shows cycling performance of DRS-LVO at 1C (in FIG. 4B, “Cap”=capacity). FIG. 4C shows voltage profiles of DRS-LVO at 1C over the course of 200 cycles.

The 60° C. testing results show that the DRS-LVO exhibits a reversible capacity of 217 mA·h/g at 1C and retains 34% (74 mA·h/g) and 18% (38 mA·h/g) of its capacity at 12.5C and 25C, respectively, at 60° C. (FIG. 4A). The cycling results at 60° C. show that the Li∥DRS-LVO cell experiences some degradation at the beginning, then maintains a stable capacity of 143 mA·h/g at 1C for 200 cycles (FIGS. 4B and 4C), indicating its long cycle life in an all-solid-state battery. The capacity decrease at the early stage may be associated with degradation at or near electrolyte-anode material interfaces at 60° C., which can be solved by material optimization.

### Example 5: Lithium-Ion Cell with Li_{5.4}PS_{4.4}Cl_{1.6} Solid Electrolyte

A Li∥DRS-LVO cell was assembled using the Cl-rich lithium argyrodite electrolyte, Li_{5.4}PS_{4.4}Cl_{1.6}. The electrode composition is 40% of DRS-LVO, 40% of solid electrolyte, and 20% of vapor-grown carbon fiber. The batteries are tested at room temperature (about 25° C.).

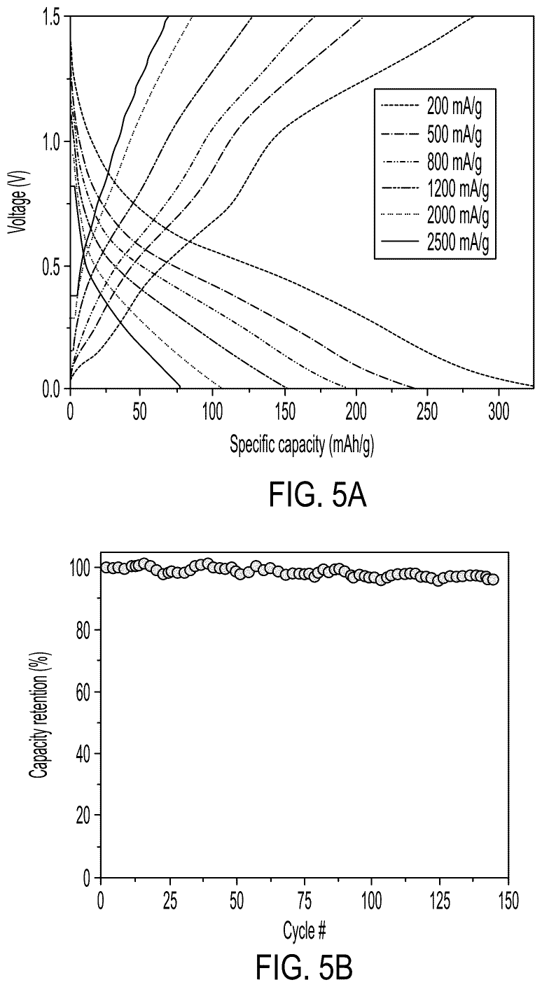

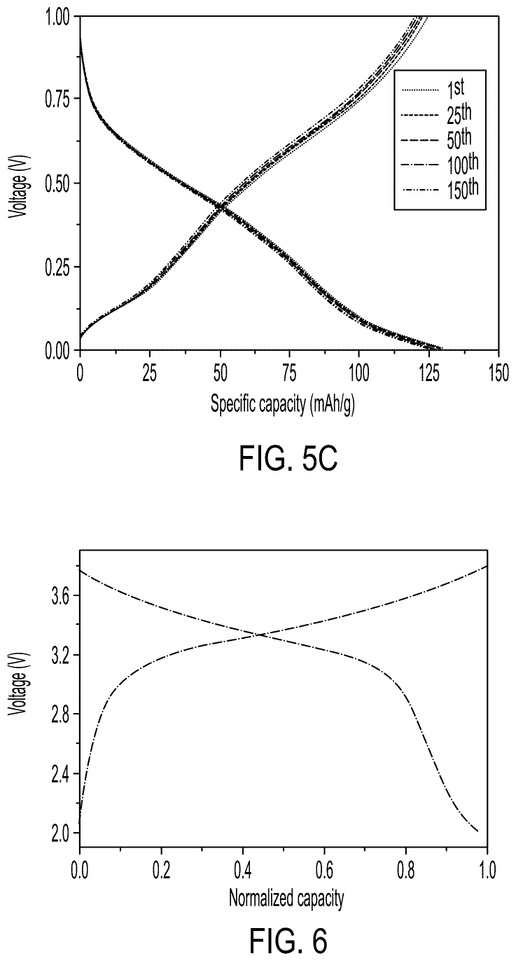

FIGS. 5A, 5B, and 5C show the performance of an all-solid-state Li∥DRS-LVO cell using the Cl-rich lithium argyrodite electrolyte Li_{5.4}PS_{4.4}Cl_{1.6}. FIG. 5A shows voltage profiles of DRS-LVO at room temperature under different rates. FIG. 5B shows cycling performance of DRS-LVO at 1C. FIG. 5C shows voltage profiles of DRS-LVO at 1C over the course of 150 cycles.

The room-temperature testing results show that the DRS-LVO exhibits a reversible capacity of 282 mA·h/g at 1C and retains 27% (77 mA·h/g) of its capacity at 12.5C (FIG. 5A). These results at room temperature show that the DRS-LVO has remarkably almost no capacity decrease at 1C for 150 cycles (FIGS. 5B and 5C), indicating its ultralong cycle life in an all-solid-state battery. The cycle life using Li_{5.4}PS_{4.4}Cl_{1.6} solid electrolyte is surprisingly long.

### Example 6: Lithium-Ion Full Cell with Li_{5.4}PS_{4.4}Cl_{1.6} Solid Electrolyte

A DRS-LVO∥NMC811 solid-state full cell was assembled using the Cl-rich lithium argyrodite electrolyte, Li_{5.4}PS_{4.4}Cl_{1.6}. The cell voltage window was 2.0-3.8 V, and the cell was operated at a temperature of 60° C. FIG. 6 shows that the full cell exhibits an average voltage of about 3.3 V.

What is claimed is:

1. A solid-state lithium-ion battery comprising:
an anode layer comprising lithium vanadium oxide, wherein said lithium vanadium oxide has a composition given by LiₐV_{b}O_{c}, wherein a=0.001-10, b=1-3, c=1-9, and a, b, and c are selected to charge-balance said LiₐV_{b}O_{c}, wherein said LiₐV_{b}O_{c} is capable of being reversibly lithiated, and wherein at least some of said LiₐV_{b}O_{c} has a disordered rocksalt structure in the Fm3̅m space group;
a solid electrolyte layer comprising a solid electrolyte; and
a cathode layer comprising a cathode material,
wherein said solid electrolyte layer is interposed between said anode layer and said cathode layer.

2. The solid-state lithium-ion battery of claim 1, wherein about 0.01 wt % to 100 wt % of said LiₐV_{b}O_{c} has a disordered rocksalt structure in the Fm3̅m space group.

3. The solid-state lithium-ion battery of claim 1, wherein said LiₐV_{b}O_{c} is selected from the group consisting of Li₃V₂O₅, Li₄V₂O₅, Li₅V₂O₅, LiV₂O₅, Li_{0.001}V₂O₅, Li₂V₂O₅, Li_{0.001}VO₂, LiVO₂, Li₂VO₂, Li_{0.001}VO₃, LiVO₃, Li₂VO₃, Li₃VO₃, Li_{0.001}V₃O₈, LiV₃O₈, Li₂V₃O₈, Li₃V₃O₈, Li_{0.001}V₂O₃, LiV₂O₃, Li₂V₂O₃, Li₃V₂O₃, and combinations thereof.

4. The solid-state lithium-ion battery of claim 1, wherein said lithium vanadium oxide further contains a dopant M that is chemically or physically contained within said lithium vanadium oxide such that its composition is given by LiₐV_{b}O_{c}M_{d}, wherein d=0.001-3, wherein a, b, c, and d are selected to charge-balance said LiₐV_{b}O_{c}M_{d}, wherein said LiₐV_{b}O_{c}M_{d} is capable of being reversibly lithiated, and wherein at least some of said LiₐV_{b}O_{c}M_{d} has a disordered rocksalt structure in the Fm3̅m space group.

5. The solid-state lithium-ion battery of claim 4, wherein about 0.01 wt % to 100 wt % of said LiₐV_{b}O_{c}M_{d} has a disordered rocksalt structure in the Fm3̅m space group.

6. The solid-state lithium-ion battery of claim 4, wherein said dopant M is selected from the group consisting of Na, K, Be, Mg, Ca, Zn, Fe, Co, Ni, Cu, Ag, Sc, B, Y, Al, La, Si, Ge, Sn, Ti, Zr, Mn, P, Nb, Ta, Cr, Mo, W, Se, N, S, F, Cl, Br, I, and combinations thereof.

7. The solid-state lithium-ion battery of claim 1, wherein said solid electrolyte is selected from the group consisting of oxides, sulfides, phosphates, argyrodites, β-aluminas, LISICON, garnets, NASICON, perovskites, antiperovskites, lithium nitrides, lithium hydrides, lithium phosphidotrielates and phosphidotetrelates, lithium metal halides, UPON, lithium thiophosphates, and combinations thereof.

8. The solid-state lithium-ion battery of claim 1, wherein said solid electrolyte is a sulfur-based superionic conductor.

9. The solid-state lithium-ion battery of claim 8, wherein said sulfur-based superionic conductor is a halogen-containing lithium argyrodite.

10. The solid-state lithium-ion battery of claim 9, wherein said halogen-containing lithium argyrodite is selected from Li_{6-ε}PS_{5-ε}X_{1+ε}, wherein −1<ε≤1, and wherein X=F, Cl, Br, I, or a combination thereof.

11. The solid-state lithium-ion battery of claim 10, wherein X=Cl, and wherein 0≤ε≤0.8.

12. The solid-state lithium-ion battery of claim 8, wherein said sulfur-based superionic conductor is selected from the group consisting of Li₂S—P₂S₅, Li₇P₃S₁₁, Li₁₀GeP₂S₁₂, Li₇SiPS₈, Li₃PS₄, Li₁₊₂ₓZn₁₋ₓPS₄ (0≤x<1), and combinations thereof.

13. The solid-state lithium-ion battery of claim 1, wherein said solid electrolyte is an oxide-based superionic conductor.

14. The solid-state lithium-ion battery of claim 13, wherein said oxide-based superionic conductor is selected from the group consisting of Li—Al₂O₃, Li₇La₃Zr₂O₁₂, Li₂₊₂ₓZn₁₋ₓGeO₄ (0≤x≤1), Li₁₊ₓZr₂SiₓP₃₋ₓO₁₂ (0<x<3), La_{2/3-x}Li₃ₓTiO₃ (0<x<⅔), LiₓX¹₃X²₂O₁₂ (X¹=La, Nd, Mg, or Ba; X²=Te, Ta, Nb, Zr, or In; and 0<x<7), and combinations thereof.

15. The solid-state lithium-ion battery of claim 1, wherein said solid electrolyte is a phosphate-based superionic conductor.

16. The solid-state lithium-ion battery of claim 15, wherein said phosphate-based superionic conductor is selected from the group consisting of Li₃PO₄, Li₁₊ₓX¹ₓX²₂₋ₓ(PO₄)₃ (X¹=Al, La, In, or Cr; X²=Ti, Ge, Zr, Hf, or Sn; and 0<x<2), and combinations thereof.

17. The solid-state lithium-ion battery of claim 1, wherein said solid electrolyte is a nitride-based superionic conductor.

18. The solid-state lithium-ion battery of claim 17, wherein said nitride-based superionic conductor is selected from the group consisting of Li₃N, LiₓPO_{y}N_{z} (0<x≤3; 0<y≤4; and 0<z≤1), and combinations thereof.

19. The solid-state lithium-ion battery of claim 1, wherein said solid electrolyte is a hydride-based superionic conductor.

20. The solid-state lithium-ion battery of claim 19, wherein said hydride-based superionic conductor is selected from the group consisting of LiBH₄, LiCB₉H₁₀, LiCB₁₁H₁₂, and combinations thereof.

21. The solid-state lithium-ion battery of claim 7, wherein said antiperovskites are selected from the group consisting of Li₃OCl, Li₃OBr, Li₃OF, Li₃OI, and combinations thereof.

22. The solid-state lithium-ion battery of claim 1, wherein said cathode material is selected from the group consisting of LiCoO₂, LiMn₂O₄, Li₂MnO₃, LiFePO₄, LiNiₓCo_{y}Al_{z}O₂ (x+y+z=1), LiMnₓNi_{y}O₄ (x+y=2), LiNiₓCo_{y}Mn_{z}O₂ (x+y+z=1), LiFeₓMn_{y}PO₄ (x+y=1), aLiNiₓCo_{y}Mn_{z}O₂·(1−a)Li₂MnO₃ (0<a<1 and x+y+z=1), and combinations thereof.

23. The solid-state lithium-ion battery of claim 22, wherein said cathode material is said LiNiₓCo_{y}Mn_{z}O₂.

24. The -state lithium-ion battery of claim 23, wherein said LiNiₓCo_{y}Mn_{z}O₂ is LiNi_{0.8}Co_{0.1}Mn_{0.1}O₂.

25. The solid-state lithium-ion battery of claim 1, wherein said solid electrolyte is also contained within said anode layer.

26. The solid-state lithium-ion battery of claim 1, wherein said solid electrolyte is also contained within said cathode layer.

27. The solid-state lithium-ion battery of claim 1, wherein said anode layer, said cathode layer, or said solid electrolyte layer further contains a noble metal in neutral or ionic form, and wherein said noble metal is optionally selected from the group consisting of Au, Ag, Pt, Rh, Pd, Ru, Os, Ir, and combinations thereof.

28. The solid-state lithium-ion battery of claim 1, wherein said anode layer further contains a second anode material selected from the group consisting of silicon, silicon oxide, graphite, hard carbon, soft carbon, a silicon-carbon composite, aluminum, magnesium, zinc, tin, tin oxide, and combinations thereof.

29. The solid-state lithium-ion battery of claim 1, wherein said anode layer further contains an anode carbon additive in sp form, sp² form, and/or sp³ form.

30. The solid-state lithium-ion battery of claim 29, wherein said anode carbon additive is graphite, graphene, carbon nanotubes, carbon fibers, ultrafine carbon, activated carbon, carbon black, nanodiamonds, hard carbon, soft carbon, or a combination thereof.

31. The solid-state lithium-ion battery of claim 1, wherein said cathode layer further contains a cathode carbon additive in sp form, sp² form, and/or sp³ form.

32. The solid-state lithium-ion battery of claim 31, wherein said cathode carbon additive is graphite, graphene, carbon nanotubes, carbon fibers, ultrafine carbon, activated carbon, carbon black, nanodiamonds, hard carbon, soft carbon, or a combination thereof.

33. The solid-state lithium-ion battery of claim 1, wherein said cathode layer is disposed on a cathode current collector, and wherein said anode layer is disposed on an anode current collector.

34. The solid-state lithium-ion battery of claim 1, wherein said solid-state lithium-ion battery contains a plurality of anode layers, a plurality of solid electrolyte layers, and a plurality of cathode layers.

35. The solid-state lithium-ion battery of claim 1, wherein said solid-state lithium-ion battery is capable of maintaining at least 80% battery capacity after performing 20,000 cycles.

36. The solid-state lithium-ion battery of claim 1, wherein said solid-state lithium-ion battery is capable of charging to 80% state of charge in 3 minutes or less.

37. The solid-state lithium-ion battery of claim 1, wherein said solid-state lithium-ion battery has an energy density of at least 200 W·h/kg.

38. The solid-state lithium-ion battery of claim 1, wherein said solid-state lithium-ion battery has an energy density of at least 650 W·h/L.

39. The solid-state lithium-ion battery of claim 1, wherein said solid-state lithium-ion battery is capable of operating in a temperature range from about −80° C. to about 350° C.

40. The solid-state lithium-ion battery of claim 1, wherein said solid-state lithium-ion battery does not undergo lithium metal plating during operation.

41. The solid-state lithium-ion battery of claim 1, wherein said solid-state lithium-ion battery is contained within a battery module/pack comprising a plurality of batteries.

42. The solid-state lithium-ion battery of claim 41, wherein said battery module/pack is contained within an electric vehicle.

43. The solid-state lithium-ion battery of claim 42, wherein said electric vehicle is an electric automobile.

44. The solid-state lithium-ion battery of claim 42, wherein said electric vehicle is an electric truck or bus.

45. The solid-state lithium-ion battery of claim 42, wherein said electric vehicle is an electric locomotive.

46. The solid-state lithium-ion battery of claim 42, wherein said electric vehicle is an electric airplane.

47. The solid-state lithium-ion battery of claim 1, wherein said solid-state lithium-ion battery is contained within a portable device.

48. The solid-state lithium-ion battery of claim 1, wherein said solid-state lithium-ion battery is contained within a smart device.

49. The solid-state lithium-ion battery of claim 1, wherein said solid-state lithium-ion battery is contained within an emergency power backup system.

50. The solid-state lithium-ion battery of claim 1, wherein said solid-state lithium-ion battery is contained within a solar-power electricity storage system.
